(19) United States
(12) Patent Application Publication
(10) Pub. No.: US 2019/0327310 A1
(43) Pub. Date: Oct. 24, 2019

(54) EFFICIENT APPROACH FOR ACHIEVING SESSION FAILOVER FOR HTTP TRAFFIC IN A SCALE OUT WEB TIER USING A SHARED SALT

(71) Applicant: Nutanix, Inc., San Jose, CA (US)

(72) Inventors: Ranjan PARTHASARATHY, Milpitas, CA (US); Zhi Yao XIE, San Jose, CA (US)

(73) Assignee: Nutanix, Inc., San Jose, CA (US)

(21) Appl. No.: 15/836,031

(22) Filed: Dec. 8, 2017

Related U.S. Application Data
(60) Provisional application No. 62/432,146, filed on Dec. 9, 2016.

(51) Int. Cl. H04L 29/08; H04L 9/32; H04L 29/06; H04L 9/08; G06F 11/20

(52) U.S. Cl. CPC H04L 67/145; H04L 9/3228; G06F 11/2025; H04L 9/0891; H04L 67/141; H04L 63/067

(57) ABSTRACT

A node at a server side of a client-server system receives a request corresponding to a user account maintained in the server side. If login credentials in the request are valid, the node generates a session and a set of values including session metadata, a timeframe, and a signature associated with the session, wherein the signature is generated from the session metadata, the timeframe, and a salt that is shared among nodes at the server side. The session and the set of values are sent to a client from which the request originated. An additional node at the server side receives a request to access the session and obtains values from a value included in the request corresponding to the signature associated with the session using the salt. Session access is granted or denied based at least in part on whether the obtained values match the session metadata and timeframe.

### CROSS-REFERENCE TO RELATED APPLICATIONS

The present application claims the benefit of priority to U.S. Patent Application No. 62/432,146, titled “SESSION FAILOVER FOR HIGH AVAILABILITY,” filed on Dec. 9, 2016, which is hereby incorporated by reference in its entirety.

### FIELD

This disclosure concerns a method, a computer program product, and a computer system for achieving session failover for HTTP traffic in a scale out web tier using a shared salt.

### BACKGROUND

In a client-server system, servers (e.g., web servers in a web tier) respond to requests (e.g., HTTP requests) received from clients via sessions that allow information to be exchanged between the servers and the clients. For a client to communicate with a server, a session is established between the server and the client that allows one or more messages to be sent from the client to the server and vice versa. The session may then be torn down at a later time. Traditionally, servers manage sessions by storing session metadata that is specific to each user who accesses a session via a client (e.g., a session identifier or “session ID,” user-identifying information, such as login credentials associated with each user, user permissions and access settings, etc.). For example, when a web server receives a request corresponding to a user account for an online retailer or a web application, if the web server authenticates the user (e.g., if login credentials provided by the user are valid), the web server generates a session and assigns a unique session ID to the session. In this example, the web server then sends the session and session ID to a client from which the request was received. Continuing with this example, the session ID may be stored at the client as an HTTP cookie and is included in each subsequent request sent from the client to the web server. In the above example, the session ID included in the requests from the client allow the web server to track the current state of the session (e.g., the contents of the user's shopping cart for the online retailer) and respond to requests subsequently received from the user within the same session in an appropriate manner.

Servers at a server side of a client-server system are often configured to handle client requests in the event that a server becomes unavailable (e.g., due to failure or scheduled down time) by achieving failover so that a user who logs in to a user account maintained in the server side is not required to log in to their account again when session failover occurs. Conventionally, failover is achieved by storing session metadata in a backend storage system, such as a distributed database system. For example, if a web server and a client are communicating via a session, the web server may store session metadata associated with the session in a distributed database system that is hosted outside of the web tier that maps information that may be used to identify each session (e.g., a session ID) to the corresponding session metadata. In this example, if the web server is included in a cluster of web servers and becomes unavailable, a load balancer can help achieve session failover by sending client requests only to web servers that are still available to handle client requests. Continuing with this example, a web server that is still available to handle client requests may access the distributed database system, allowing session metadata associated with the session to be retrieved by the web server after performing a database lookup (e.g., using the session ID included in each client request). In the above example, the web server may handle a request for a session that previously would have been handled by the web server that is now unavailable by retrieving and loading session metadata specific to that session from the distributed database system.

However, maintaining a storage system, such as a distributed database system, in which session metadata may be stored persistently, may pose several problems. For example, if several servers are simultaneously accessing session metadata stored in a distributed database system, network traffic will increase, which may cause delays in responding to client requests. As an additional example, managing a database schema, a system catalog, and recovering from failures to ensure that the consistency of a distributed database system is maintained can be tedious, time-consuming, and expensive. Maintaining session metadata in a storage system also may pose a scalability problem since a large amount of session metadata potentially may be stored in the storage system and as the number of sessions that must be managed increases, more storage must be added to the storage system to accommodate the growth, further adding to the expense and the complications of maintaining the storage system. Moreover, since a database lookup must be performed at the server side to retrieve session metadata that is specific to a session in response to receiving a request to access the session, as the number of sessions increases, the amount of time that is required to retrieve the session metadata for a particular session also increases, causing further delays in responding to client requests.

Therefore, there is a need for an improved approach for achieving session failover for traffic directed to a server side of a client-server system, such as HTTP traffic directed to web servers in a scale out web tier.

### SUMMARY

Embodiments of the present invention provide a method, a computer program product, and a computer system for achieving session failover for HTTP traffic in a scale out web tier using a shared salt.

According to some embodiments, a client-server system is implemented to achieve session failover for traffic directed to a server side of a client-server system. A first node (e.g., a web server) at the server side receives a first request corresponding to a user account maintained in the server side. The first node determines whether login credentials included in the first request are valid. Responsive to determining that the login credentials are valid, the first node generates a session and a set of values associated with the session. The set of values associated with the session may include session metadata, a timeframe associated with the session, and a signature associated with the session. The signature may be generated based at least in part on the session metadata, the timeframe associated with the session, and a salt that is shared among nodes at the server side. The session and the set of values are then sent to a client from which the first request originated. The set of values may be stored in a cookie in a persistent storage location accessible via a browser executing on the client.

A second node at the server side then receives a second request to access the session. The second request may include an additional set of values that correspond to the session metadata, the timeframe associated with the session, and the signature associated with the session. Using the salt, the second node obtains values from the value corresponding to the signature included in the second request and grants or denies access to the session based at least in part on whether the values obtained from the signature match a subset of the additional set of values corresponding to the session metadata and the timeframe associated with the session. In various embodiments, the second node also may grant or deny access to the session based at least in part on additional factors, such as whether an IP address included in the second request matches an IP address of a client from which the second request was received and whether the timeframe associated with the session has elapsed.

In some embodiments, the salt that is shared among the nodes at the server side may be changed (e.g., periodically). In such embodiments, the second node may obtain values from the value corresponding to the signature included in the second request to access the session using the salt and an additional salt (i.e., a previous salt) shared among the nodes at the server side. In various embodiments, the salt also may be shared among a plurality of applications, such that the first request corresponding to the user account maintained in the server side may correspond to a request corresponding to a user account for a first application and the second node at the server side may receive a request to access a second application. In such embodiments, access to the second application may be granted or denied based at least in part on whether values obtained from a value corresponding to the signature included in the request to access the second application match values corresponding to the session metadata and the timeframe associated with the session that also are included in the request to access the second application.

Further details of aspects, objects and advantages of the invention are described below in the detailed description, drawings and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1A illustrates a client-server system for achieving session failover for traffic directed to a server side of a client-server system by storing session metadata in a database system according to some embodiments of the invention.

FIG. 1B illustrates a client-server system for achieving session failover for traffic directed to a server side of a client-server system using a shared salt according to some embodiments of the invention.

FIG. 2 is a flowchart for achieving session failover for traffic directed to a server side of a client-server system using a shared salt according to some embodiments of the invention.

FIGS. 3A-3I illustrate an example of achieving session failover for traffic directed to a server side of a client-server system using a shared salt according to some embodiments of the invention.

FIG. 4 is a flowchart for determining whether values obtained from a signature match values corresponding to session metadata and a timeframe associated with the session according to some embodiments of the invention.

FIGS. 5A-5E illustrate an example of determining whether values obtained from a signature match values corresponding to session metadata and a timeframe associated with the session according to some embodiments of the invention.

FIG. 6A illustrates an example networked virtualization system according to some embodiments of the invention.

FIG. 6B illustrates an alternative example networked virtualization system according to some embodiments of the invention.

FIG. 7 illustrates a system to implement a virtualization management console according to some embodiments of the invention.

FIG. 8 illustrates a computing environment having multiple underlying systems/clusters to be managed, where a separate management node exists for each of the underlying systems/clusters.

FIG. 9 is a block diagram of a computing system suitable for implementing an embodiment of the present invention.

### DETAILED DESCRIPTION OF THE EMBODIMENTS OF THE INVENTION

The present disclosure provides an improved approach for achieving session failover for HTTP traffic in a scale out web tier using a shared salt.

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

This disclosure will now discuss an approach for achieving session failover for traffic directed to a server side of a client-server system using a shared salt. To achieve session failover for traffic directed to a server side of a client-server system, a node at the server side receives a request corresponding to a user account maintained in the server side, in which the request includes login credentials that are specific to the user account. Responsive to determining that the login credentials provided in the request are valid, the node generates a session and a set of values associated with the session, which may include session metadata, a timeframe associated with the session, and a signature associated with the session. The signature may be generated based at least in part on the session metadata, the timeframe associated with the session, and a salt that is shared among nodes at the server side. The session and the set of values are sent to a client from which the request originated. A request to access the session subsequently may be received at the same node or at a different node at the server side, in which the subsequent request includes an additional set of values, including a value corresponding to the signature associated with the session. The node at which the second request is received then obtains values from the value corresponding to the signature using the shared salt. Access to the session may be granted or denied by this node based at least in part on whether the obtained values match a subset of the additional set of values corresponding to the session metadata and the timeframe associated with the session.

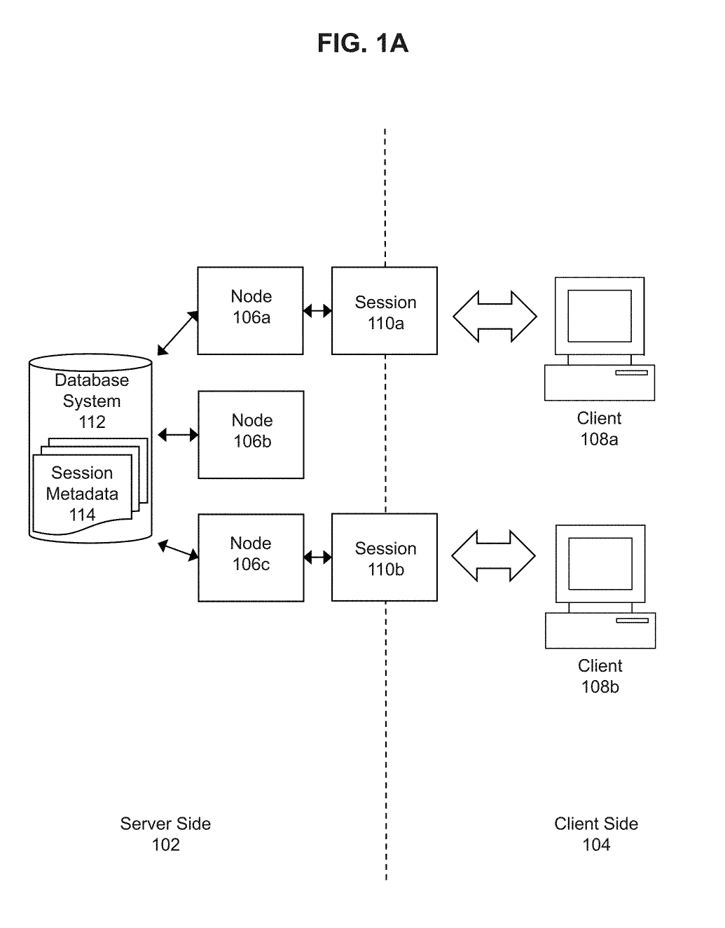

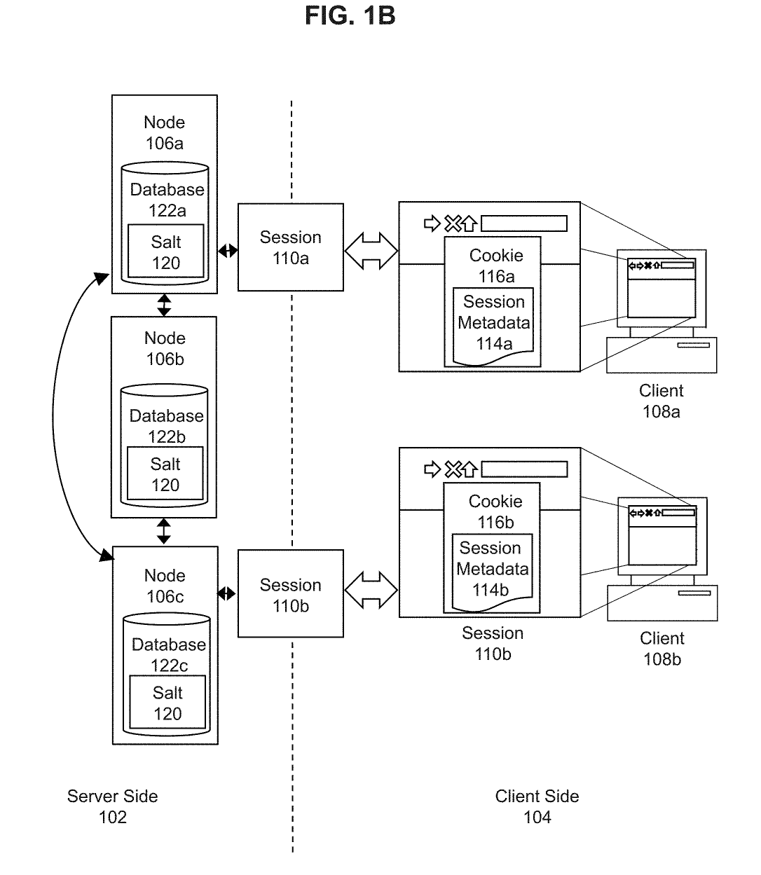

For illustrative purposes, FIGS. 1A and 1B show a client-server system in which two clients 108a-b at the client side 104 are communicating with two of three nodes 106a-c at the server side 102 via sessions 110a-b. However, in various embodiments, additional clients 108 at the client side 104 may communicate with additional nodes 106 at the server side 102 via additional sessions 110 that are not depicted in FIGS. 1A and 1B. Additionally, each node 106a-c is depicted as communicating with at most one client 108a-b. However, in various embodiments, each node 106a-c may communicate with multiple clients 108a-b via multiple sessions 110a-b. Furthermore, conventional components of client-server systems, such as load balancers, API layers, and the like are not shown so as to not obscure the components of the client-server system to be discussed with regard to FIGS. 1A and 1B.

In FIGS. 1A and 1B, the client side 104 includes one or more clients 108a-b that may be operated by users having user accounts maintained in the server side 102 (e.g., user accounts for one or more applications running on the nodes 106a-c at the server side 102). The clients 108a-b may correspond to any type of computing station that may be used to operate or interface with the nodes 106a-c. Examples of such computing stations may include workstations, personal computers, laptop computers, or remote computing terminals. Each client 108a-b may include a display device, such as a display monitor or a screen, for displaying interface elements and for reporting data to a user. Each client 108a-b also may comprise one or more input devices for a user to provide operational control over the activities of the applications, such as a mouse, a touch screen, a keypad, or a keyboard. The users of the clients 108a-b may correspond to any individual, organization, or other entity that uses a client 108a-b to access applications running on the nodes 106a-c at the server side 102.

In FIGS. 1A and 1B, the server side 102 includes one or more nodes 106a-c that may correspond to servers (e.g., web servers in a scale out web tier) that are configured to respond to requests originating from the clients 108a-b at the client side 104. In various embodiments, the requests originating from the clients 108a-b may correspond to requests to access one or more applications running on the nodes 106a-c. For example, requests from clients 108a-b may include requests to access web applications such as email applications, document sharing applications, social networking systems, etc. In some embodiments, the server side 102 may include nodes 106a-c corresponding to different types of servers. For example, in some embodiments, one or more of the nodes 106a-c at the server side 102 may correspond to Java Tomcat servers while one or more additional nodes 106a-c at the server side 102 may correspond to Python Flask servers.

As mentioned above, although not depicted in FIGS. 1A and 1B, in some embodiments, the server side 102 may include one or more load balancers. A load balancer may distribute workloads originating from the clients 108a-c at the client side 104 across the nodes 106a-c to optimize the use of the resources of the nodes 106a-c, to speed up response time, to maximize throughput, and to help prevent the nodes 106a-c from becoming overtaxed. A load balancer also may increase reliability and availability. For example, in the event that a node 106a-c at the server side 102 becomes unresponsive/unavailable, a load balancer may help the server side 102 to achieve failover by diverting traffic to other nodes 106a-c at the server side 102.

FIG. 1A illustrates a client-server system for achieving session failover for traffic directed to a server side of a client-server system by storing session metadata in a database system according to some embodiments of the invention. As shown in this figure, the server side 102 includes a database system 112, which is a storage location in which session metadata 114 (i.e., metadata associated with each session 110a-b) is stored in a persistent manner. The database system 112 also may store additional types of information associated with applications running on the nodes 106a-c at the server side 102 (e.g., user account information associated with each user of each application, such as login credentials). For example, the database system 112 may store email address and password combinations used to authenticate users of a web application running on the nodes 106a-c at the server side 102.

The database system 112 may comprise any combination of physical and logical structures as is ordinarily used for database systems, such as Hard Disk Drives (HDDs), Solid State Drives (SSDs), logical partitions, and the like. The database system 112 is illustrated as a single database that is directly accessible by the nodes 106a-c at the server side 102. However, in some embodiments, the database system 112 may correspond to a distributed database system having multiple separate databases that contain some portion of the session metadata 114. In such embodiments, the databases may be located in different physical locations and some of the databases may be accessible via a remote server.

The session metadata 114 stored in the database system 112 may include various types of metadata that may be associated with a session 110a-b. Examples of session metadata 114 include: user-identifying information for a user requesting to access an application running on a node 106a-c at the server side 102 (e.g., a username, an email address, an IP address of a client device used to access the node 106a-c, etc.), user preferences (e.g., language, geographic region, etc.), user permissions/authorizations (e.g., to access or modify various types of information), transaction history (e.g., previous actions performed by a user within a session 110a-b), a unique identifier associated with each session 110a-b (e.g., a session ID), etc. For example, suppose that nodes 106a-c at the server side 102 are web servers for an online shopping website and that each session 110a-b is specific to a user of the online shopping website. In this example, the session metadata 114 stored in the database system 112 for a particular session 110a-b may include: a user's first and last name, email address, and shipping and billing address; an IP address of a mobile device used to access the session 110a-b; items included in the user's shopping cart and/or wish list; information describing alerts that the user has requested to receive about items in their shopping cart/wish list; information describing the user's order and browsing history; etc.

The session metadata 114 may be stored in the database system 112 by each node 106a-c at the server side 102 in response to each request received from a client 108a-b via a session 110a-b. For example, upon validating user credentials included in a request received from client 108a corresponding to a user account, node 106a may generate session 110a within a web application running on node 106a and create a unique session ID associated with session 110a. In this example, the session ID may then be stored in the database system 112 in association with a date and a time that session 110a was created and information subsequently received from client 108a via session 110a (e.g., information describing actions performed by the user in the web application, information describing user preferences indicated by the user in the web application, etc.). The session metadata 114 also may include information that maps the session metadata 114 to identifiers associated with the sessions 110a-b. In the above example, the session metadata 114 may include information that maps the session metadata 114 for session 110a to the unique session ID associated with session 110a (e.g., as a key-value pair).

The session metadata 114 may be retrieved by each node 106a-c at the server side 102 in response to receiving a request from a client 108a-b at the client side 104. Continuing with the above example, suppose that node 106a becomes unavailable to handle requests and that a load balancer subsequently directs a request received from client 108a to access session 110a to node 106b. In this example, node 106b may determine whether the request to access session 110a includes the session ID associated with session 110a. If node 106b determines that the request to access session 110a includes the session ID associated with session 110a, node 106b may access the database system 112, retrieve the session metadata 114 for session 110a, load the session metadata 114, and grant client 108a access to session 110a. However, if node 106b determines that the request to access session 110a does not include the session ID associated with session 110a, node 106b may not load the session metadata 114 for session 110a and may deny client 108a access to session 110a. Similarly, if a user in the above example logs out of their user account or if session 110a has expired by the time that node 106b receives the request to access session 110a, even if the request to access session 110a includes the session ID associated with session 110a, node 106b may deny access to session 110a to the client 108a. In embodiments in which a node 106a-c at the server side 102 denies a request to access a session 110a-b, the node 106a-c may prompt a client 108a-b at the client side 104 from which the request was received to log in to a user account (e.g., in a web application) before a new session 110a-b may be created.

In contrast to FIG. 1A in which the session metadata 114 is stored in the database system 112, FIG. 1B illustrates a client-server system for achieving session failover for traffic directed to a server side of a client-server system using a shared salt according to some embodiments of the invention. As shown in FIG. 1B, the server side 102 does not store session metadata 114 in a database system 112 at the server side 102; rather, the session metadata 114a-b is stored at the client side 104. In some embodiments, the session metadata 114a-b for each session 110a-b is stored in a cookie 116a-b in a persistent storage location accessible via a browser executing on a client 108a-b. In the example of FIG. 1B, in which client 108a communicates with node 106a via session 110a, session metadata 114a that is specific to session 110a is stored in a persistent storage location that client 108a uses to store cookies (e.g., in a file system accessible by a browser executing on client 108a). Similarly, since client 108b communicates with node 106c via session 110b, session metadata 114b that is specific to session 110b is stored in a persistent storage location that client 108b uses to store cookies.

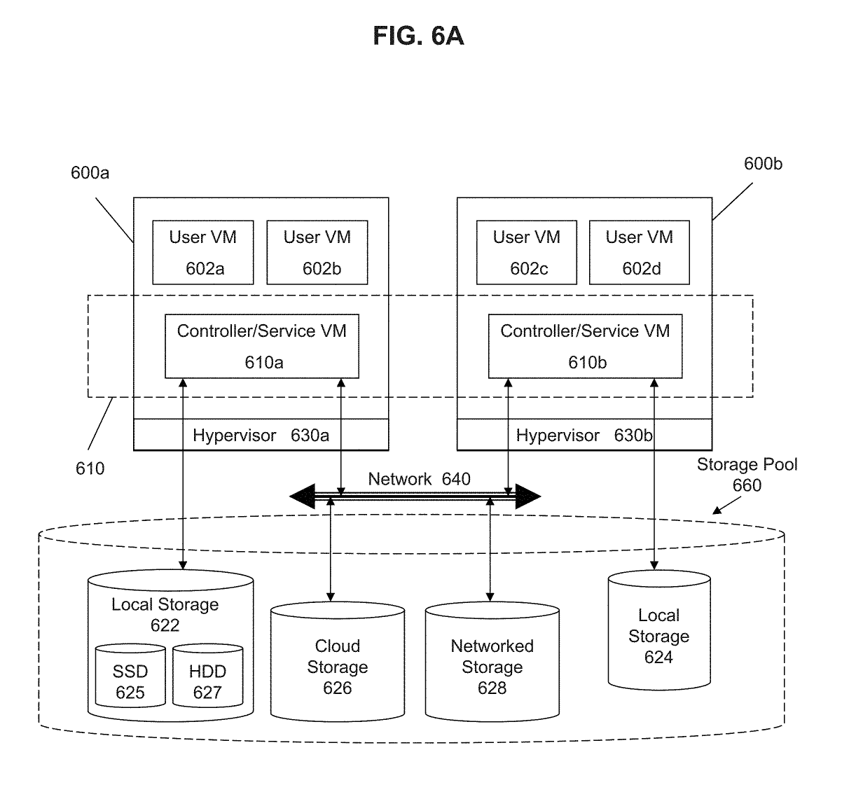

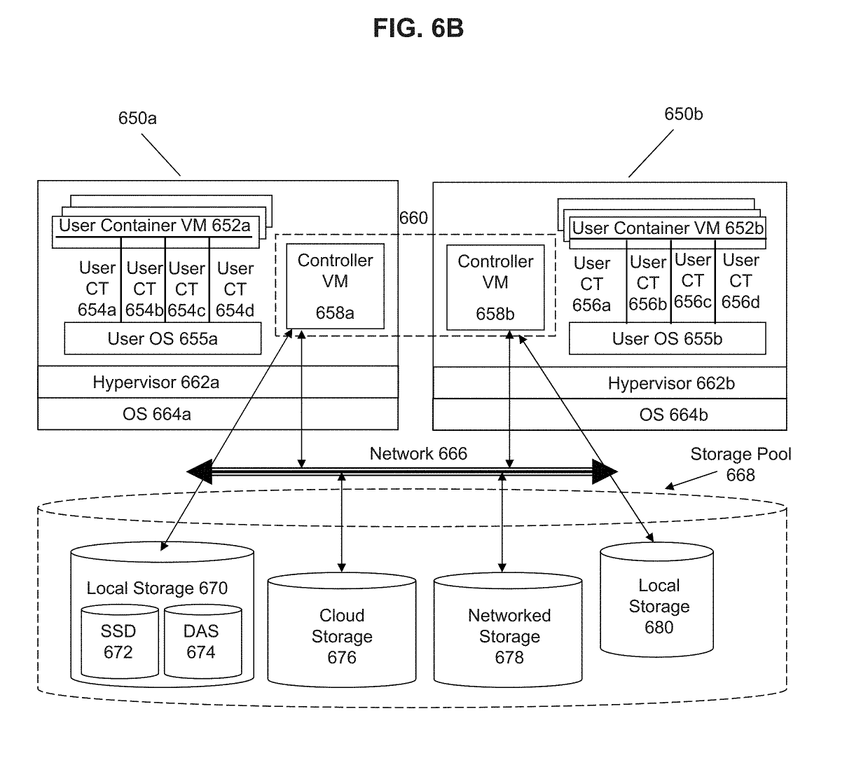

As shown in FIG. 1B, a database system 112 is not required at the server side 102 to achieve session failover for traffic directed to the server side 102 of the client-server system using a shared salt. In some embodiments, the nodes 106a-c at the server side 102 may comprise a hyperconverged infrastructure, in which each node 106a-c integrates compute, storage, and networking infrastructure. For example, each node 106a-c may include its own storage resources (i.e., database 122a-c). Furthermore, in various embodiments, the nodes 106a-c at the server side 102 may comprise a networked virtualization system, in which each node 106a-c supports a number of virtual machines, or “VMs.” Examples of a networked virtualization system are described below in conjunction with FIGS. 6A-6B.

As illustrated in the approach for achieving session failover depicted in FIG. 1B, the nodes 106a-c at the server side 102 may communicate with each other. The nodes 106a-c may communicate various types of information with each other, such as a salt 120, which may be used to determine whether a request from a client 108a-b at the client side 104 to access a session 110a-b should be granted or denied, as will be further discussed below. The nodes 106a-c also may communicate other types of information with each other, such as a key from which the salt 120 is derived (e.g., a private SSL key). For example, the nodes 106a-c may communicate a private SSL key with each other and each node 106a-c may generate the salt 120 from the first 16 bytes of the private SSL key. In embodiments in which the nodes 106a-c at the server side 102 each include a database 122a-c, each of the databases 122a-c may store a salt 120. In such embodiments, the salt 120 is stored exclusively at the server side 102 of the client-server system and is not communicated to or stored at the client side 104.

Although not depicted in FIG. 1B, the databases 122a-c also may store additional types of data, such as a previous salt (further described below), a key, and/or information associated with users of one or more applications running on the nodes 106a-c (e.g., user account information, such as login credentials associated with each user). Furthermore, although not depicted in FIG. 1B, in some embodiments, information stored in the databases 122a-c also or alternatively may be stored in one or more shared databases that may be accessed by one or more of the nodes 106a-c at the server side 102. In the embodiments described in conjunction with FIG. 1B, the session metadata 114 is stored only at the client side 104 and not at the server side 102. Hence, in comparison to the approach illustrated in FIG. 1A, the approach illustrated in FIG. 1B is a more efficient low-storage approach for achieving session failover for traffic directed to a server side 102 of a client-server system.

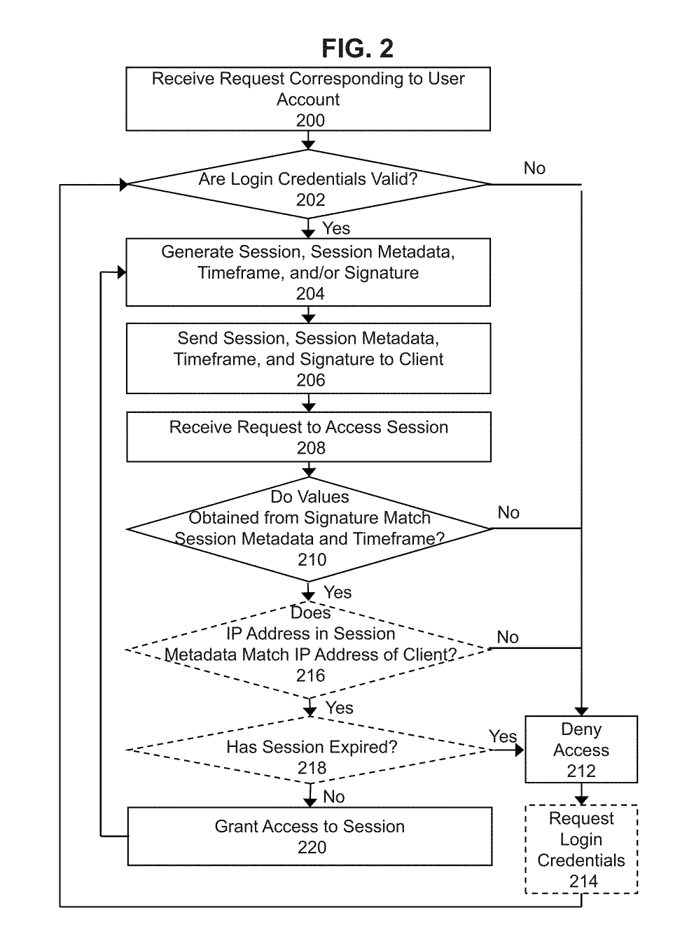

FIG. 2 is a flowchart for achieving session failover for traffic directed to a server side of a client-server system using a shared salt according to some embodiments of the invention. Some of the steps illustrated in the flowchart are optional in different embodiments. In some embodiments, the steps may be performed in an order different from that described in FIG. 2.

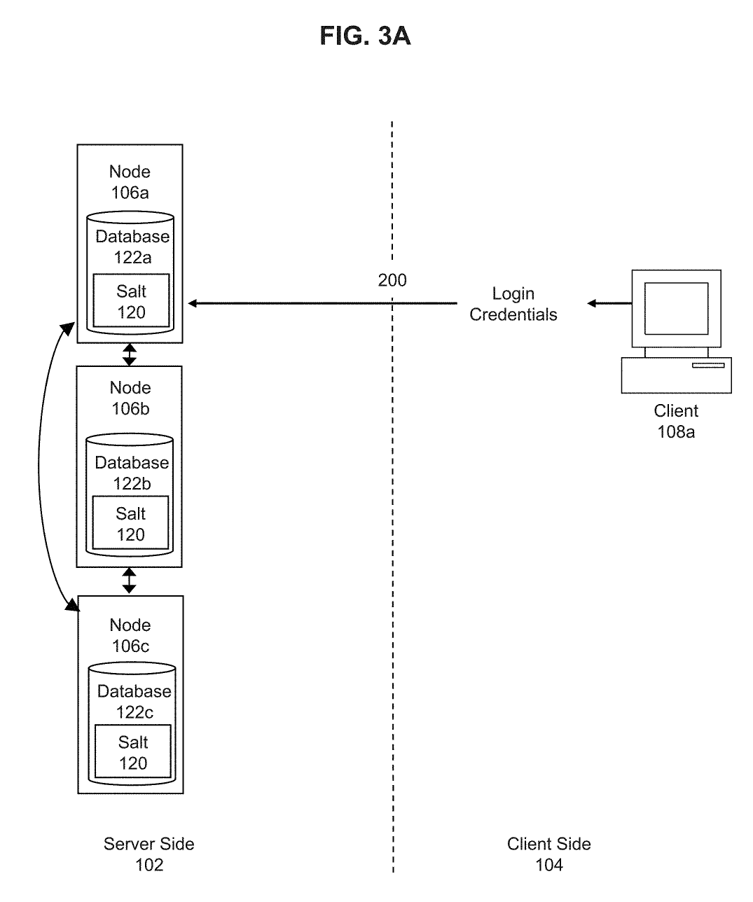

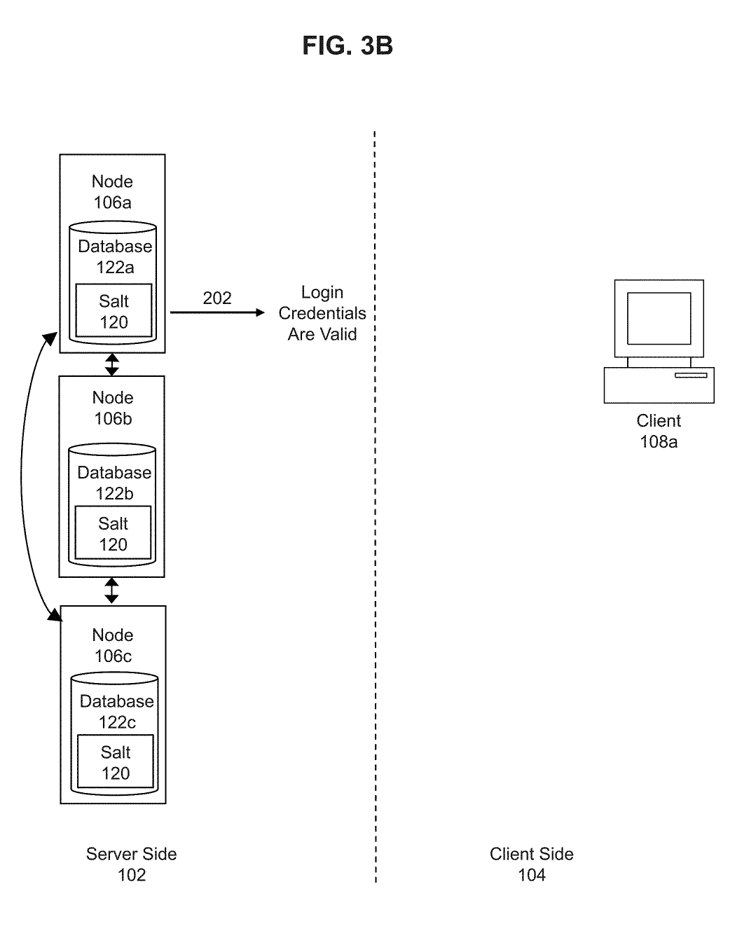

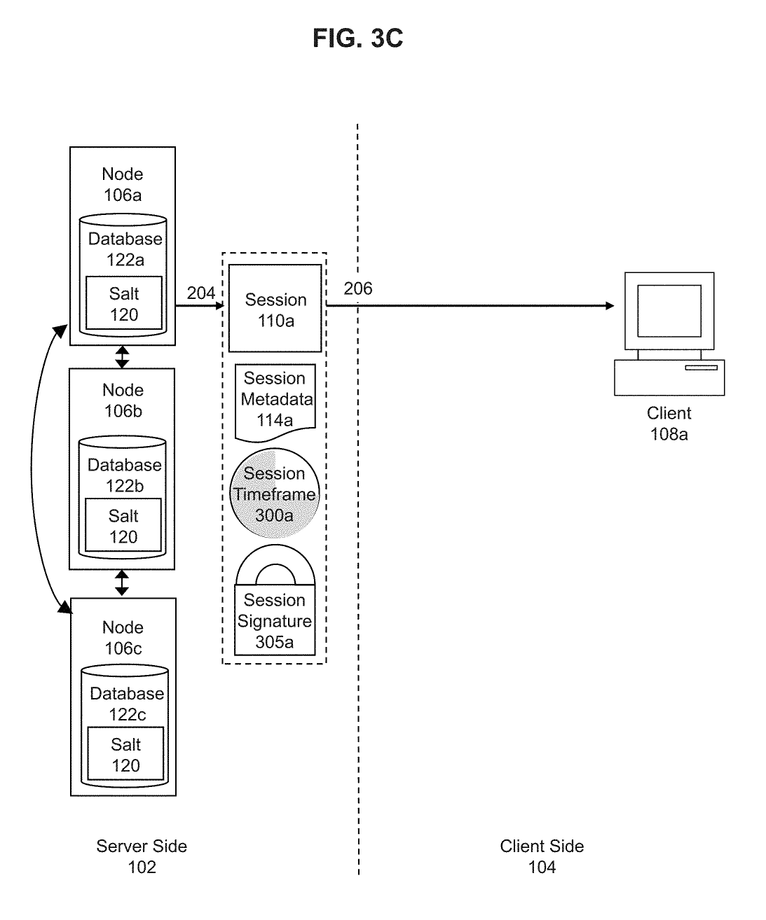

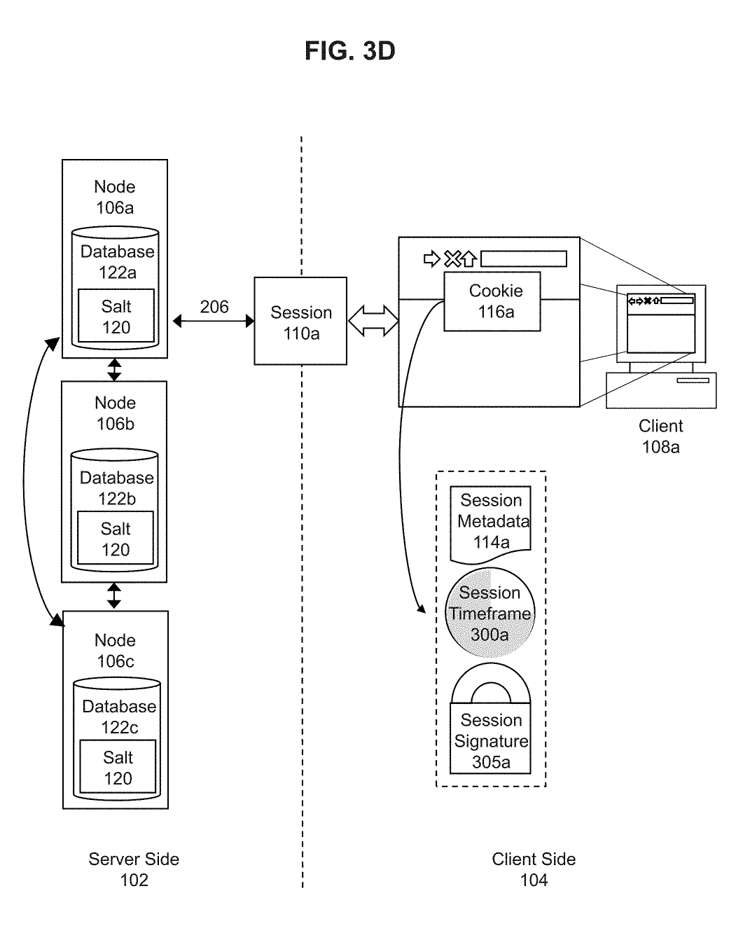

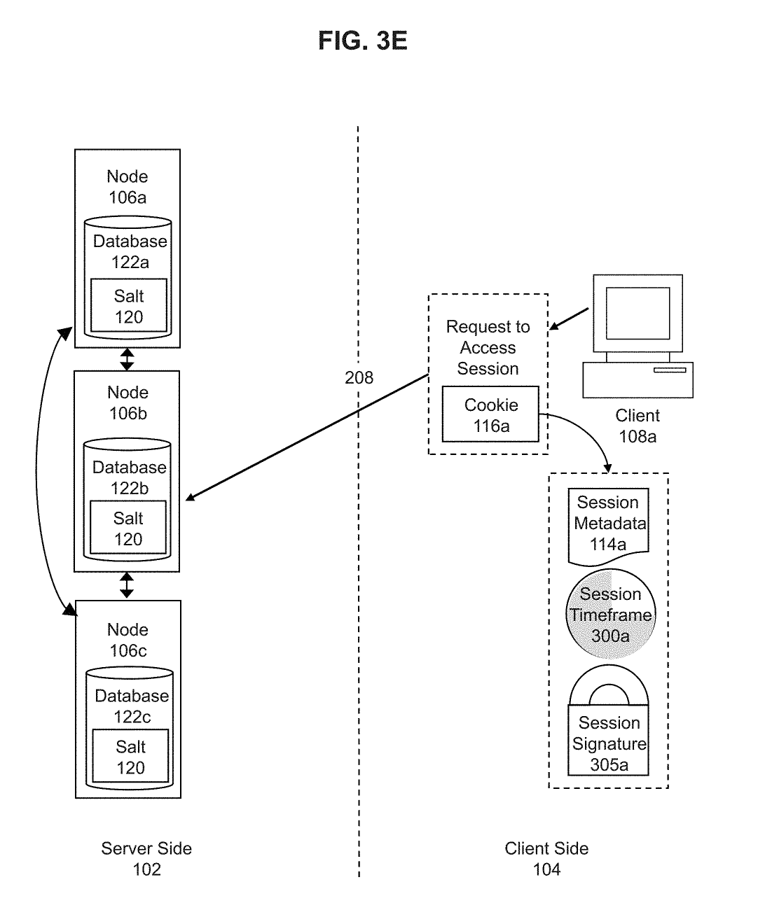

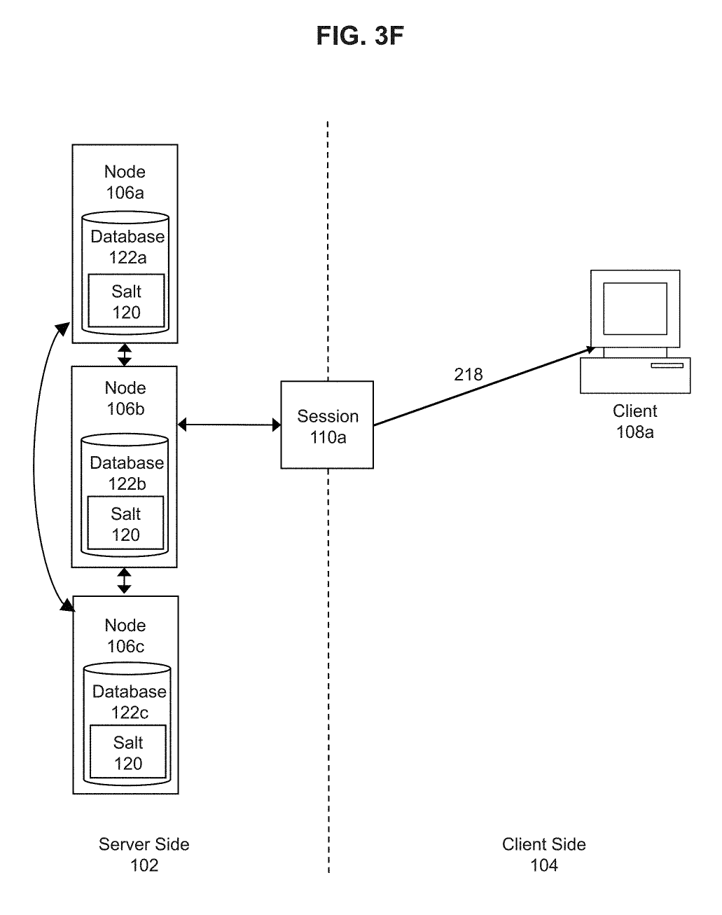

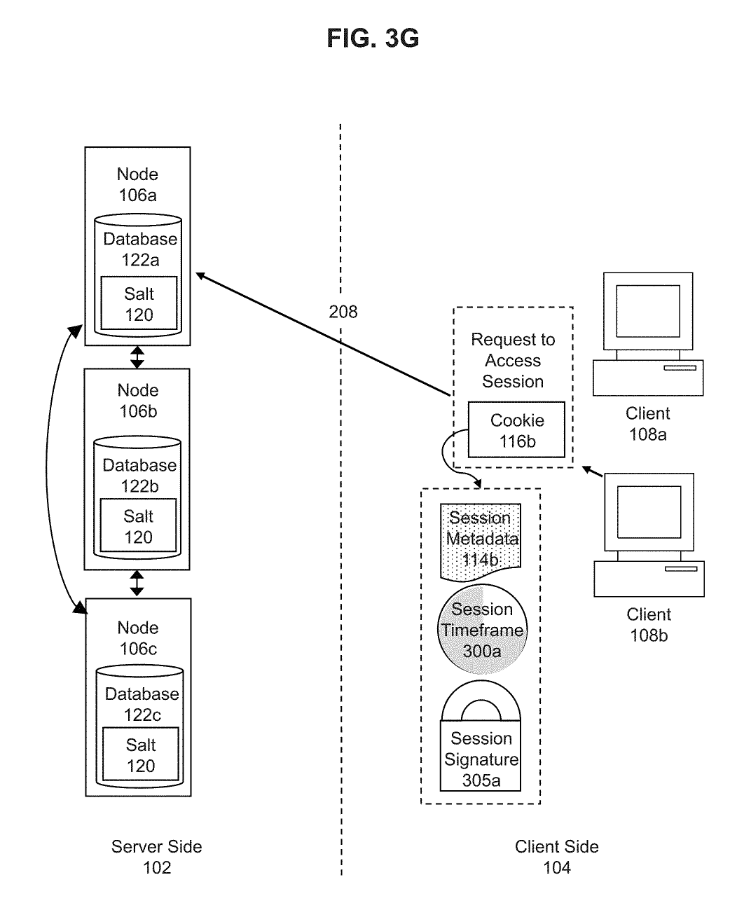

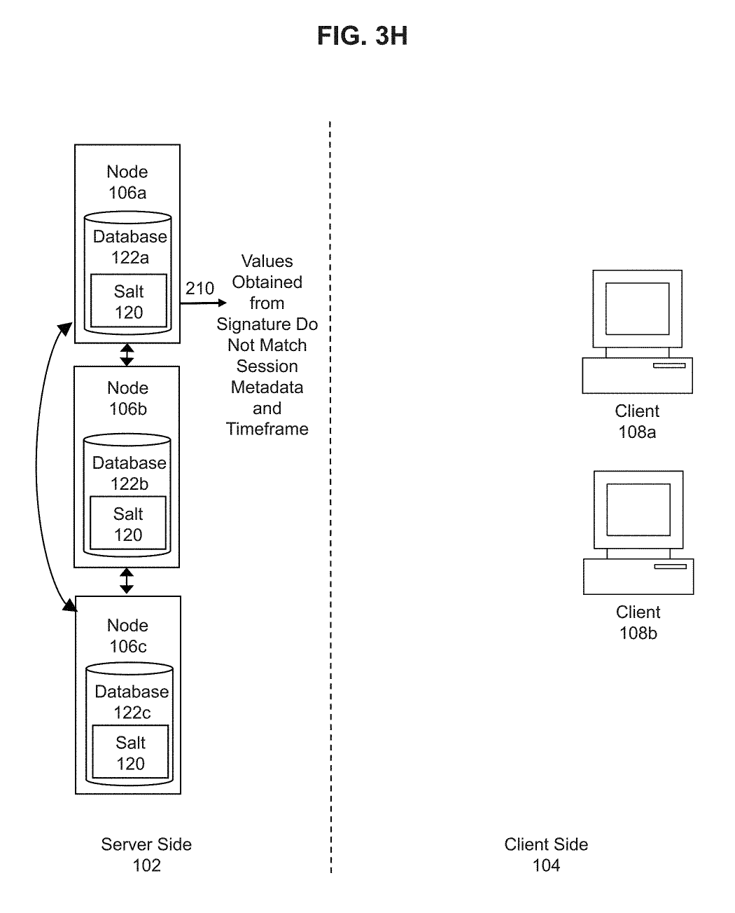

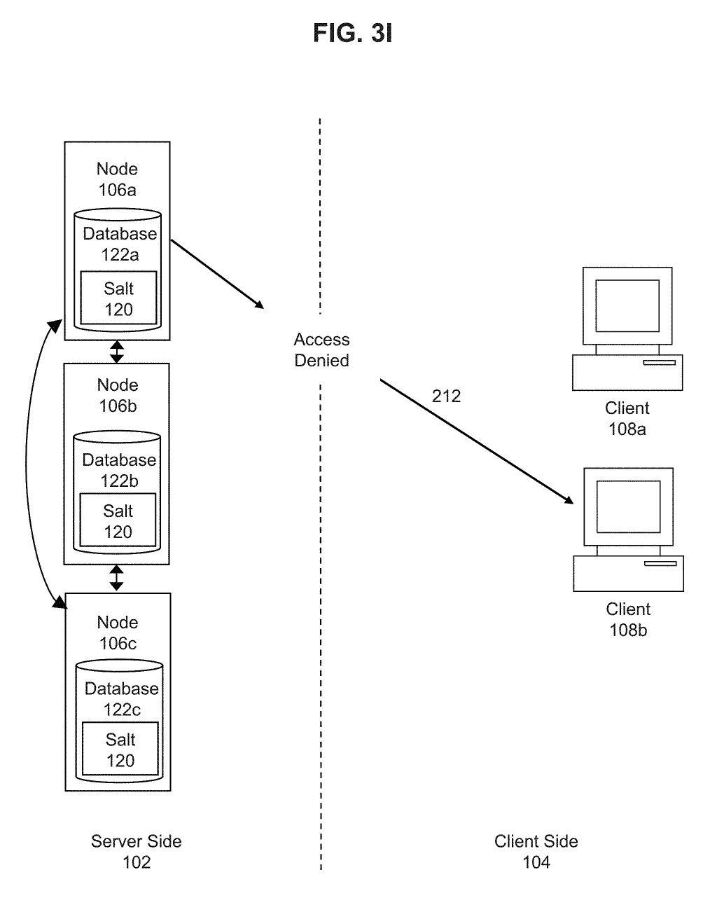

As shown in FIG. 2, the flowchart begins when a node 106 at the server side 102 receives a request corresponding to a user account maintained in the server side 102 (in step 200). The request may include login credentials specific to the user account (e.g., a username and password combination). In some embodiments, the request also may include various additional types of information, such as an IP address associated with a client 108 at the client side 104 from which the request originated. In various embodiments, the request may correspond to a request to access one of multiple applications (e.g., email applications, word processing applications, etc.) running on the nodes 106a-c at the server side 102. As shown in the example of FIG. 3A, node 106a at the server side 102 receives login credentials included in a request corresponding to a user account maintained in the server side 102 from client 108a at the client side 104 (in step 200). As described above in conjunction with FIG. 1B, each of the nodes 106a-c in this example may have a database 122a-c in which a salt 120 shared among the nodes 106a-c may be stored. In some embodiments, each of the nodes 106a-c also or alternatively may access a shared database at which the salt 120 is stored.

Referring back to FIG. 2, after the node 106 at the server side 102 has received the request corresponding to the user account maintained in the server side 102, the node 106 may determine whether the login credentials included in the request are valid (in step 202). The node 106 at which the request is received may determine whether the login credentials are valid by accessing user account information maintained in the server side 102. As described above, in some embodiments, the user account information may be maintained in a database 122 (e.g., a database 122 that is local to the node 106 or that is shared among the nodes 106). If the node 106 determines that the login credentials are not valid, the node 106 may deny the request (in step 212) and may send a notification to the client 108 indicating that access has been denied. In some embodiments, if the node 106 denies the request, the node 106 also may send a request for login credentials to the client 108 (in step 214) and repeat step 202 upon receiving additional login credentials from the client 108.

Alternatively, if the node 106 determines that the login credentials included in the request are valid, the node 106 may generate a session 110, session metadata 114 associated with the session 110, a timeframe associated with the session 110, and a signature associated with the session 110 (in step 204). The timeframe associated with the session 110 may describe a span of time during which the session 110 is valid. The timeframe may indicate a start time associated with the session 110 (e.g., a time that the session 110 was created) and an end time associated with the session 110 (e.g., a time that the session 110 will expire). Once a timeframe associated with the session 110 has elapsed, the session 110 may be terminated and a user associated with the session 110 may be logged out of their user account. For example, if a session 110 has a timeframe of 15 minutes, once 15 minutes has elapsed since the last time a node 106 at the server side 102 received a request from a client 108 via the session 110, the session 110 will expire and the node 106 will log the user out of their user account. In this example, a new session 110 may be created if and when valid login credentials for the user account are subsequently received at a node 106 at the server side 102. In some embodiments, the timeframe may be set to a default value, while in alternative embodiments, the timeframe may be set manually (e.g., by a system administrator).

In some embodiments, the signature associated with the session 110 is generated from the session metadata 114, the timeframe associated with the session 110, and the salt 120 that is shared among the nodes 106. Furthermore, in some embodiments, the session metadata 114 may be encrypted using the salt 120. For example, the node 106 may encrypt the session metadata 114 using the key and also obtain a signature associated with the session 110 by encrypting the session metadata 114 and the timeframe associated with the session 110 using the salt 120. The session 110, session metadata 114, timeframe, and the signature associated with the session 110, may then be sent to the client 108 (in step 206). In some embodiments, the session metadata 114 associated with the session 110, the timeframe associated with the session 110, and the signature associated with the session 110 may be sent back to the client 108 in a cookie header (e.g., using a standard HTTP approach to set a cookie 116). In such embodiments, the session metadata 114, the timeframe, and the signature associated with the session 110 may be stored in a cookie 116 in a persistent storage location accessible via a browser executing on the client 108.

As shown in the examples of FIGS. 3B-3D, which continue the example discussed above with respect to FIG. 3A, in response to determining that the login credentials received at node 106a are valid (as shown in step 202 in FIG. 3B), node 106a generates session 110a, session metadata 114a, a session timeframe 300a, and a session signature 305a that are specific to session 110a (as shown in step 204 of FIG. 3C). Once generated, the session 110a, the session metadata 114a, the session timeframe 300a, and the session signature 305a that are specific to session 110a are sent to client 108a at the client side 104 (as shown in step 206 of FIG. 3C). As described above, in some embodiments, the session metadata 114a, the session timeframe 300a, and the session signature 305a may be sent back to client 108a in a cookie header (e.g., a Set-Cookie HTTP response header) and stored in a cookie 116a in a persistent storage location accessible via a browser executing on client 108a, as shown in FIG. 3D.

Referring again to FIG. 2, after the node 106 sends the session 110, the session metadata 114, the timeframe, and the signature associated with the session 110 to the client 108 at the client side 104, a node 106 at the server side 102 subsequently receives a request to access the session 110 (in step 208) from the same or a different client 108. The request to access the session 110 may be received at the same node 106 at which the request corresponding to the user account was received in step 200 or at a different node 106 (e.g., depending on one or more load balancing policies). The request to access the session 110 may include a set of values including a value corresponding to the session metadata 114, a value corresponding to the session timeframe, and a value corresponding to the session signature associated with the session 110. For example, prior to sending the request to access the session 110, a client 108 sending the request may access a file system accessible by a browser executing on the client 108, retrieve a cookie 116 in which the set of values are stored, and include the values in the request (e.g., in the header of the request). As shown in the example of FIG. 3E, which continue the example discussed above with respect to FIGS. 3A-3D, in some embodiments, the session metadata 114a, the session timeframe 300a, and the session signature 305a may be received by a node 106b at the server side 102 in a cookie 116a (in step 208). As also shown in FIG. 3E, in some embodiments, the request to access the session 110a may be received at a node 106b that is different from the node 106a at which the session 110a was generated.

As described above, in some embodiments, the request received in step 200 corresponds to a request to access one of multiple applications running on the nodes 106 at the server side 102. In such embodiments, a request to access a second application also or alternatively may be received at the same node 106 at which the request to access the first application was received or at a different node. In such embodiments, the request to access the second application may include the set of values including the value corresponding to the session metadata 114, the value corresponding to the session timeframe, and the value corresponding to the session signature associated with the session 110.

In some embodiments, if the session metadata 114, the timeframe, and the signature associated with a session 110 are sent back to a client 108 in a cookie header (e.g., a Set-Cookie HTTP response header) and stored in a cookie 116 in a persistent storage location accessible via a browser executing on the client 108, the client 108 may delete the cookie 116 from the persistent storage location prior to sending a request to access the session 110 to a node 106 at the server side 102. In such embodiments, rather than receiving a request to access the session 110 (in step 208), a node 106 at the server side 102 may receive another request corresponding to the user account (in step 200). For example, if a request received at a node 106 at the server side 102 does not include session metadata 114, a session timeframe, and a signature associated with a session 110, the node 106 may interpret the request to be a request corresponding to a user account maintained in the server side 102 and may prompt the user to provide login credentials associated with the user account.

Referring back to FIG. 2, once the node 106 at the server side 102 has received the request to access the session 110, this node 106 may determine whether values obtained from the value corresponding to the signature included in the request to access the session 110 match the values corresponding to the session metadata 114 and the timeframe that also are included in the request to access the session 110 (in step 210). The node 106 may obtain the values from the value corresponding to the signature using the salt 120. For example, in embodiments in which the signature is obtained by encrypting the session metadata 114 and the timeframe associated with the session 110 using the salt 120, the node 106 may attempt to decrypt the value corresponding to the signature using the salt 120.

Based at least in part on whether the values obtained from the value corresponding to the signature match the session metadata 114 and the timeframe associated with the session 110, the node 106 may grant the client 108 access to the session 110 (in step 220), as illustrated in FIG. 3F which continues the example discussed above with respect to FIGS. 3A-3E. Furthermore, as shown in FIG. 2, once the node 106 grants the client 108 access to the session 110, the node 106 may then repeat step 204, such that new session metadata 114, a new session timeframe, and/or a new signature associated with the session 110 are generated. In embodiments in which a new session timeframe is generated, the session timeframe is extended (e.g., for another 15 minutes). In some embodiments, each time the session metadata 114, the timeframe, and the signature associated with the session 110 are sent to the client 108 (in step 206), these values overwrite the previous session metadata 114, timeframe, and signature stored at the client 108.

Alternatively, if the values obtained from the value corresponding to the signature do not match the session metadata 114 and the timeframe associated with the session 110, the node 106 may deny the client 108 access to the session 110 (in step 212). In some embodiments, if the node 106 denies the client 108 access to the session 110, the node 106 may send a notification to the client 108 indicating that access has been denied. Furthermore, in some embodiments, if the node 106 denies the client 108 access to the session 110, the node 106 may log the user associated with the session 110 out of the user account. In embodiments in which the request received in step 200 corresponds to a request to access one of multiple applications running on the nodes 106 at the server side 102 and a request to access a second application is subsequently received at a node 106 at the server side, the node 106 may determine whether to grant or deny access to the second application and subsequently grant or deny access to the second application in an analogous manner.

FIGS. 3G-3I, which continue the example discussed above with respect to FIGS. 3A-3F, illustrate an example in which a node 106 denies the request from a client 108 to access a session 110. As shown in FIG. 3G, suppose that a request to access session 110a received from client 108b includes values corresponding to session metadata 114b that has been modified from the session metadata 114a that was generated by node 106a (e.g., by a malicious user attempting to gain unauthorized access to session 110a), as well as the session timeframe 300a and the session signature 305a, which remain unmodified (in step 208). Since the session signature 305a was generated from the original (unmodified) session metadata 114a, the session timeframe 300a, and the salt 102, node 106a will determine that the values obtained from the session signature 305a using the salt 120 do not match the session metadata 114b and the session timeframe 300a included in the request to access the session 110a, as shown in FIG. 3H (in step 210). Therefore, as shown in FIG. 3I, node 106a will deny client 108b access to session 110a (in step 212). In the above example, if the session timeframe 300a and/or the session signature 305a also or alternatively had been modified, node 106a also would have determined that the values obtained from the session signature 305a or a modified value corresponding to the session signature 305a would not have matched the session metadata 114a and the session timeframe 300a or modified values corresponding to the session metadata 114a and the session timeframe 300a also included in the request to access session 110a.

Referring once more to FIG. 2, in various embodiments, if the node 106 at which the request to access the session 110 was received determines that the values obtained from the value corresponding to the signature match the values corresponding to the session metadata 114 and the timeframe also included in the request to access the session 110, the node 106 also may grant or deny access to the session 110 based at least in part on additional factors. In some embodiments, the node 106 also may determine whether to grant or deny access to the session 110 based on whether an IP address included in the request to access the session 110 matches an IP address of the client 108 from which the request was received (in step 216). For example, even if the values obtained from the value corresponding to the signature match the values corresponding to the session metadata 114 and the timeframe included in the request to access the session 110, if the IP address included in the session metadata 114 does not match the IP address of the client 108 from which the request to access the session 110 was received, the node 106 may deny the client 108 access to the session 110. Otherwise, the node 106 may grant the client 108 access to the session 110 or determine whether to grant or deny access to the session 110 based on additional factors.

In some embodiments, the node 106 at which the request to access the session 110 was received also may determine whether to grant or deny access to the session 110 based on whether the timeframe associated with the session 110 has elapsed (in step 218). For example, suppose that the node 106 has determined that the values obtained from the value corresponding to the signature match the values corresponding to the session metadata 114 and the timeframe included in the request to access the session 110 and that the timeframe indicates that the session 110 expires within 15 minutes of the time that the timeframe was generated. In this example, if the request to access the session 110 was received at the node 106 more than 15 minutes after the timeframe was generated, the node 106 may deny the client 108 access to the session 110. Alternatively, in this example, if the request to access the session 110 was received at the node 106 within 15 minutes after the timeframe was generated, the node 106 may grant the client 108 access to the session 110. Similar to the situation described above in step 202, in which a node 106 denies a request corresponding to a user account, if the node 106 denies the request to access the session 110, the node 106 also may send a request for login credentials to the client 108 (in step 214) and repeat step 202 upon receiving additional login credentials from the client 108.

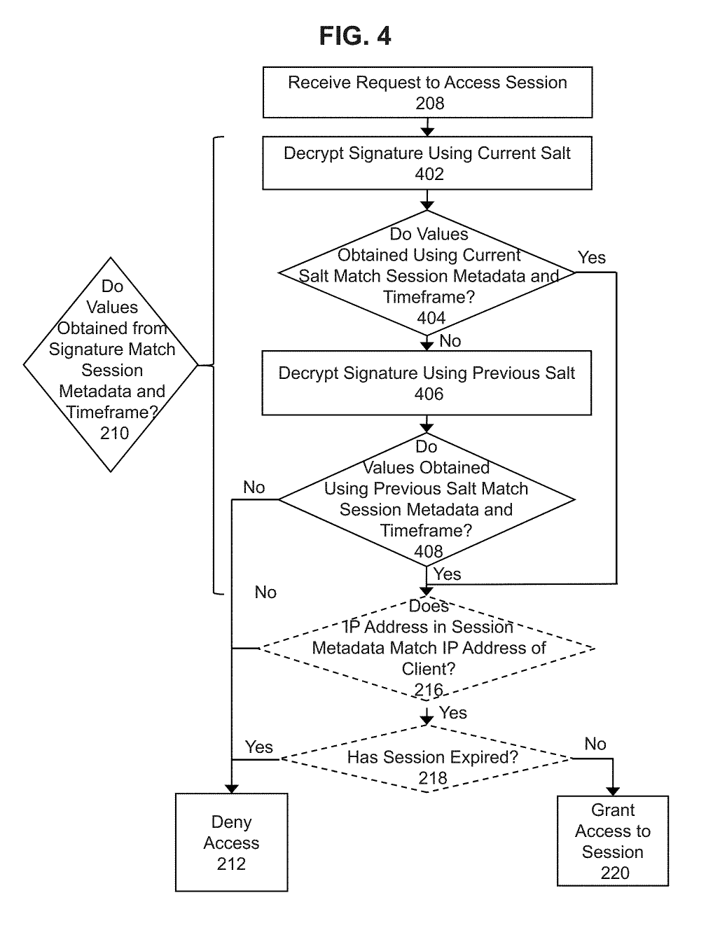

In some embodiments, to enhance the security of access to the sessions 110, the salt 120 that is shared among the nodes 106 at the server side 102 may be changed. For example, the salt 120 may be changed manually by a system administrator. As an additional example, the salt 120 may be changed when a system administrator changes a key (e.g., an SSL key) from which the salt 120 is derived. As yet another example, the salt 120 may be configured to change automatically (e.g., on a periodic basis). In embodiments in which the salt 120 is changed, the nodes 106 at the server side 102 may share multiple salts 120 (e.g., a current salt and a previous salt). In such embodiments, a node 106 may determine whether values obtained from the value corresponding to the signature included in a request to access a session 110 match values corresponding to the session metadata 114 and the timeframe using each of the salts 120, as described below, in conjunction with FIG. 4.

FIG. 4 is a flowchart for determining whether values obtained from a signature match values corresponding to session metadata and a timeframe associated with the session according to some embodiments of the invention. Some of the steps illustrated in the flowchart are optional in different embodiments. In some embodiments, the steps may be performed in an order different from that described in FIG. 4.

As shown in FIG. 4, the flowchart begins when a node 106 at the server side 102 receives a request to access a session 110 (in step 208). As described above in conjunction with FIG. 2, the request to access the session 110 may include a set of values including a value corresponding to the session metadata 114, the session timeframe, and the session signature associated with the session 110. The node 106 at the server side 102 that receives the request may then determine whether values obtained from the value corresponding to the signature associated with the session 110 match the values corresponding to the session metadata 114 and the timeframe included in the request (in step 210). In some embodiments, the node 106 may do so by first decrypting the signature using the current salt (in step 402) and then determining whether the values obtained from the value corresponding to the signature using the current salt match the values corresponding to the session metadata 114 and the timeframe included in the request to access the session 110 (in step 404).

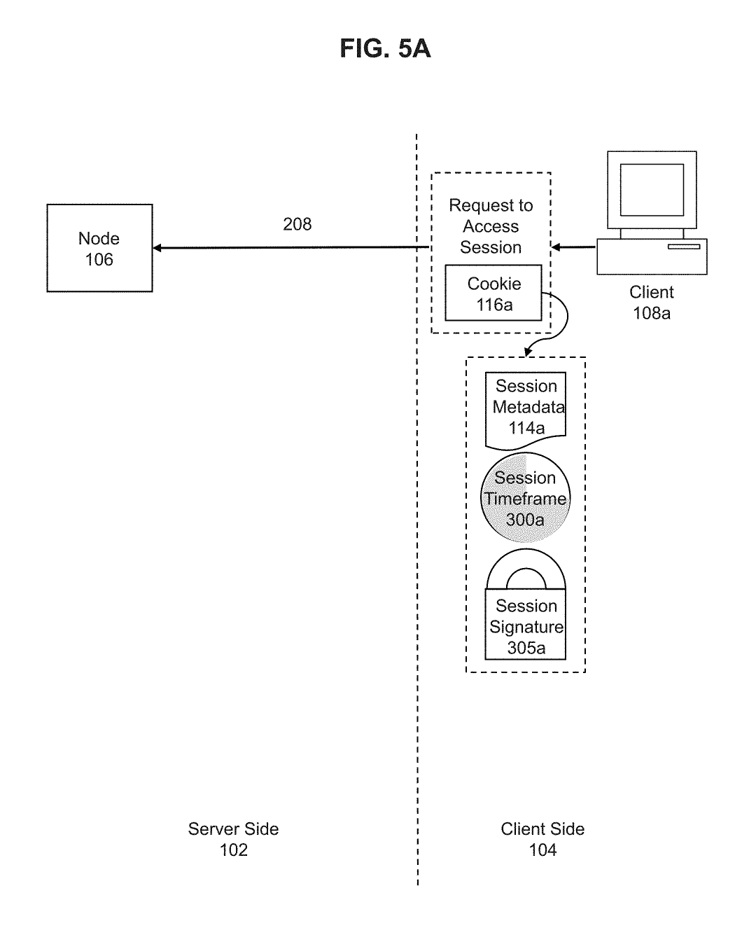

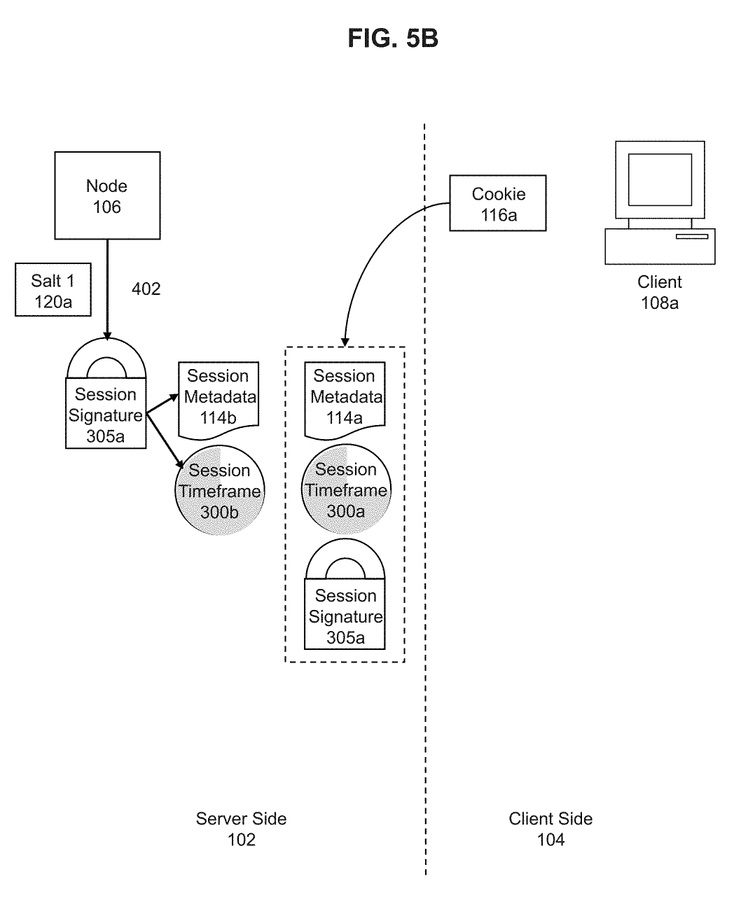

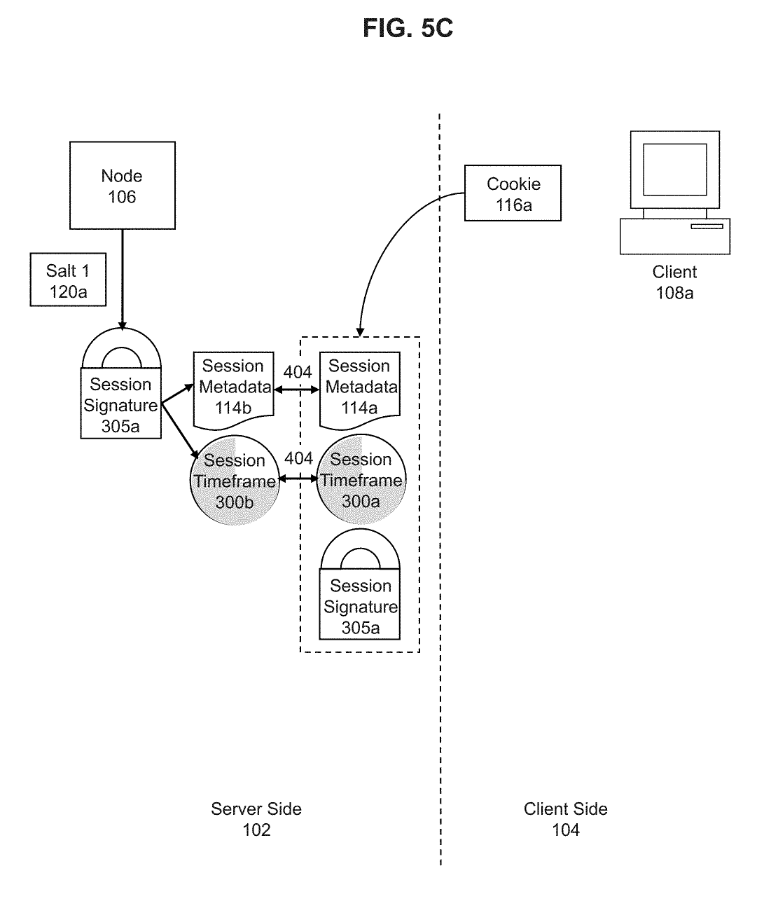

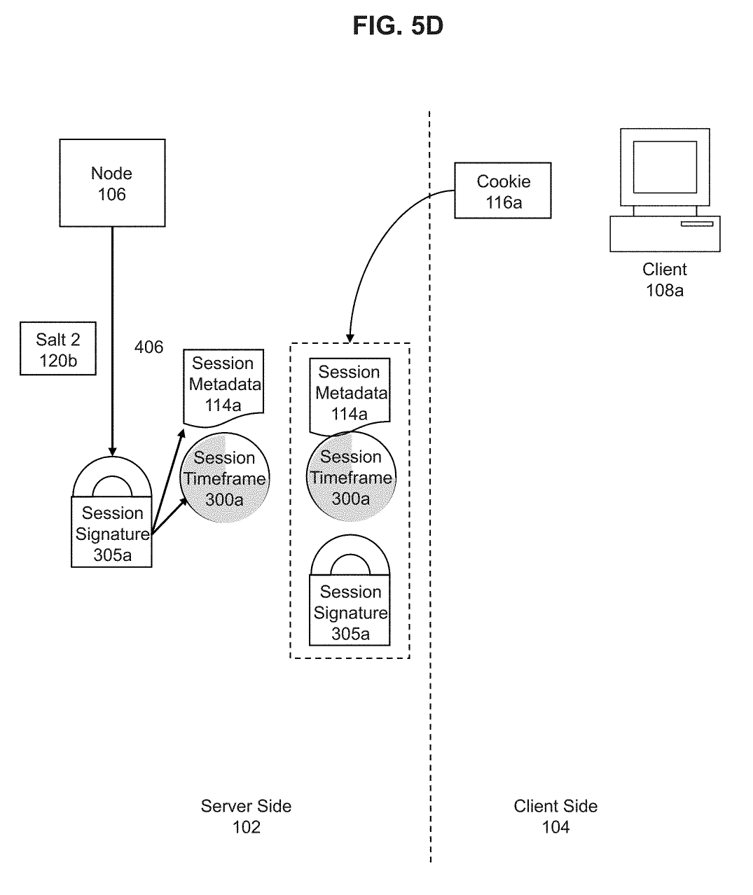

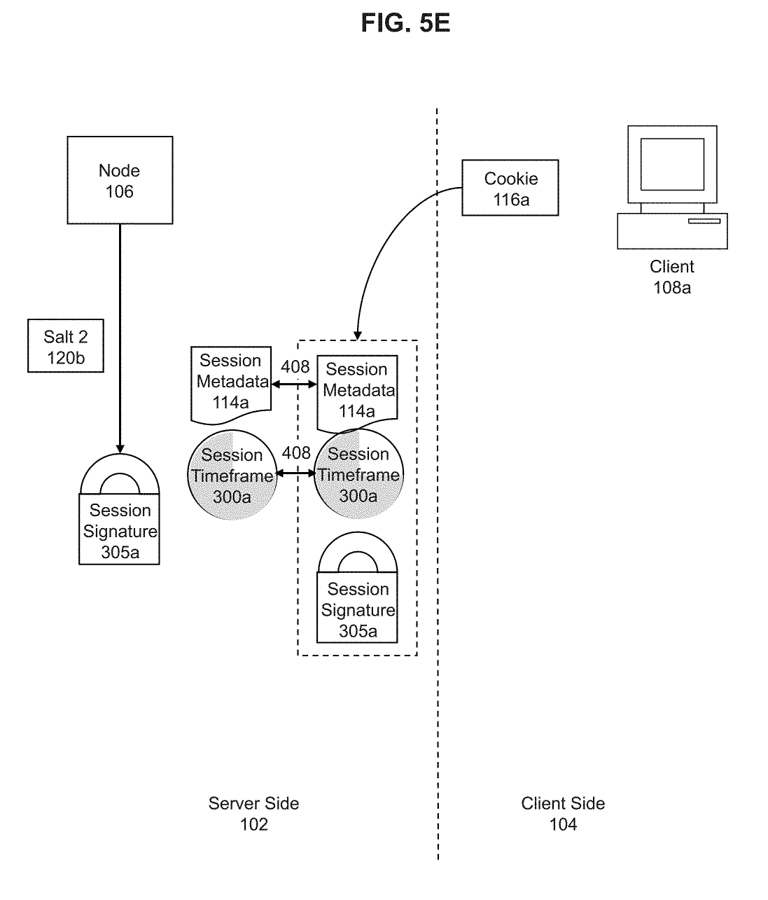

FIGS. 5A-5C illustrate examples of the steps described thus far with respect to FIG. 4. As shown in FIG. 5A, the request to access a session 110 may be received by a node 106 at the server side 102 from client 108a at the client side 104 in conjunction with a cookie 116a (in step 208). Values stored in the cookie 116a may include session metadata 114a, a session timeframe 300a, and a session signature 305a that are specific to the session 110 being requested. Then, as shown in FIG. 5B, the node 106 may decrypt the signature 305a using a current salt (Salt 1 120a) to obtain session metadata 114b and session timeframe 300b (in step 402). Assuming that the signature 305a was generated using a previous salt that has since been changed to the current salt 120a, as shown in FIG. 5C, the node 106 will determine that the session metadata 114b and the session timeframe 300b obtained from the session signature 305a do not match the values corresponding to the session metadata 114a and the session timeframe 300a included in the request to access the session 110 (in step 404).

Referring again to FIG. 4, if the node 106 determines that the values obtained using the current salt match the values corresponding to the session metadata 114 and the timeframe included in the request to access the session 110, the node 106 may then determine whether to deny or grant the client 108 access to the session 110 based on additional factors (e.g., in steps 216 and 218) and deny or grant access to the session 110 accordingly (e.g., in steps 212 and 220, respectively). However, if the node 106 determines that the values obtained using the current salt do not match the values corresponding to the session metadata 114 and the timeframe included in the request to access the session 110, the node 106 may then decrypt the signature using the previous salt (in step 406) and then determine whether the values obtained from the value corresponding to the signature using the previous salt match the values corresponding to the session metadata 114 and the timeframe included in the request to access the session 110 (in step 408).

For example, as illustrated in FIGS. 5D and 5E, which continue the example discussed above with respect to FIGS. 5A-5C, the node 106 may decrypt the signature 305a using a previous salt (Salt 2 120b) to obtain session metadata 114a and a session timeframe 300a (in step 406). As noted above, since the signature 305a was generated using the previous salt 120b that has since been changed to the current salt 120a, as shown in FIG. 5E, the node 106 will determine that the session metadata 114a and the session timeframe 300a obtained from the value corresponding to the session signature 305a using the previous salt 120b match the values corresponding to the session metadata 114a and the session timeframe 300a included in the request to access the session 110 (in step 408). Therefore, as described above with respect to FIG. 4, the node 106 may then determine whether to deny or grant the client 108a access to the session 110 based on additional factors (e.g., in steps 216 and 218) and deny or grant access to the session 110 accordingly (e.g., in steps 212 and 220, respectively).

Referring once more to FIG. 4, if the node 106 determines that the values obtained using the previous salt do not match the values corresponding to the session metadata 114 and the timeframe included in the request to access the session 110, the node 106 may deny the client 108 access to the session 110 (in step 212). As described above in conjunction with FIG. 2, in some embodiments, if the node 106 determines that the values obtained using the previous salt do not match the values corresponding to the session metadata 114 and the timeframe included in the request to access the session 110, the node 106 may send a notification to the client 108 indicating that access has been denied. As also described above in conjunction with FIG. 2, in some embodiments, the node 106 also may log a user associated with the requested session 110 out of the user account, send a request for login credentials to the client 108 (in step 214), and repeat step 202 upon receiving additional login credentials from the client 108.

FIG. 6A illustrates a clustered virtualization environment in which some embodiments are implemented. In some embodiments, the server side 102 of the client-server system may operate in a clustered virtualization environment. For example, the nodes 106 at the server side 102 may correspond to clusters of web servers, the resources of which may be virtualized.

The architecture of FIG. 6A can be implemented for a distributed platform that contains multiple servers 600a and 600b that manages multiple-tiers of storage. The multiple tiers of storage may include storage that is accessible through a network 640, such as cloud storage 626 or networked storage 628 (e.g., a SAN or “storage area network”). Unlike the prior art, the present embodiment also permits local storage 622/624 that is within or directly attached to the server and/or appliance to be managed as part of the storage pool 660. Examples of such storage include Solid State Drives (henceforth “SSDs”) 625 or Hard Disk Drives (henceforth “HDDs” or “spindle drives”) 627. These collected storage devices, both local and networked, form a storage pool 660. Virtual disks (or “vDisks”) can be structured from the storage devices in the storage pool 660, as described in more detail below. As used herein, the term vDisk refers to the storage abstraction that is exposed by a Controller/Service VM to be used by a user VM. In some embodiments, the vDisk is exposed via iSCSI (“internet small computer system interface”) or NFS (“network file system”) and is mounted as a virtual disk on the user VM.

Each server 600a or 600b runs virtualization software, such as VMware ESX(i), Microsoft Hyper-V, or RedHat KVM. The virtualization software includes a hypervisor 630a/630b to manage the interactions between the underlying hardware and the one or more user VMs 602a, 602b, 602c, and 602d that run client software.

A special VM 610a/610b is used to manage storage and I/O activities according to some embodiment of the invention, which is referred to herein as a “Controller/Service VM.” This is the “Storage Controller” in the currently described architecture. Multiple such storage controllers coordinate within a cluster to form a single system. The Controller/Service VMs 610a/610b are not formed as part of specific implementations of hypervisors 630a/630b. Instead, the Controller/Service VMs run as virtual machines above hypervisors 630a/630b on the various servers 600a and 600b, and work together to form a distributed system 610 that manages all the storage resources, including the locally attached storage 622/624, the networked storage 628, and the cloud storage 626. Since the Controller/Service VMs run above the hypervisors 630a/630b, this means that the current approach can be used and implemented within any virtual machine architecture, since the Controller/Service VMs of embodiments of the invention can be used in conjunction with any hypervisor from any virtualization vendor.

Each Controller/Service VM 610a-b exports one or more block devices or NFS server targets that appear as disks to the client VMs 602a-d. These disks are virtual, since they are implemented by the software running inside the Controller/Service VMs 610a-b. Thus, to the user VMs 602a-d, the Controller/Service VMs 610a-b appear to be exporting a clustered storage appliance that contains some disks. All user data (including the operating system) in the client VMs 602a-d resides on these virtual disks.

Significant performance advantages can be gained by allowing the virtualization system to access and utilize local (e.g., server-internal) storage 622 as disclosed herein. This is because I/O performance is typically much faster when performing access to local storage 622 as compared to performing access to networked storage 628 across a network 640. This faster performance for locally attached storage 622 can be increased even further by using certain types of optimized local storage devices, such as SSDs 625. Further details regarding methods and mechanisms for implementing the virtualization environment illustrated in FIG. 6A are described in U.S. Pat. No. 8,601,473, issued on Dec. 3, 2013, which is hereby incorporated by reference in its entirety.

FIG. 6B illustrates an alternative approach for virtualized computing environments using containers. Generally, containers are a type of operating-system level application virtualization, in which the containers run applications in individual execution environments that are isolated from the host operating system and from each other. Some existing systems for running containerized applications include Linux LXC and Docker.

Containers running applications (e.g., containerized applications) have the benefit of being very fast to get up and running because no guest operating system must be installed for the application. The container may interface with the host computer or computers on a network through one or more virtualized network connections, which is managed by a container manager. For example, a web-server container may run a web-server application which is addressed by a IP addressed assigned to the container. To address or access the web-server container, a user or computer may use the IP address, which is intercepted by a container manager and routed to the container. Because the container is isolated from the host operating system, such as if the container application is compromised (e.g., hacked), the malicious entity doing the hacking will be trapped inside the container. However, to increase security, a containerized system may be implemented within a virtual machine. In this way, containerized applications can be quickly modified/updated within the container execution environment, and if one or more of the containers is breached, it will not affect the physical host computer because the container execution environment is still behind a virtual machine.

In FIG. 6B, an approach is illustrated for running containers within a distributed storage system, such as the system of FIG. 6A. Though FIG. 6B illustrates a particular architecture involving a controller virtual machine and user virtual machine which has user containers, one of ordinary skill in the art appreciates that other configurations may be implemented as well. Other approaches, and configurations are discussed in U.S. Application No. 62/171,990, filed on Jun. 5, 2015, which is hereby incorporated by reference in its entirety.

In FIG. 6B, a distributed platform contains multiple servers 650a and 650b that manage multiple-tiers of storage. In some embodiments, the servers 650a and 650b are physical machines with hardware layer such as memory or processors (not depicted) upon which an operating system may be installed. The managed multiple tiers of storage include storage that is accessible through a network 666, such as cloud storage 676 or networked storage 678 (e.g., a SAN or “storage area network”). Additionally, the present embodiment also permits local storage 670 and/or 680 that is within or directly attached to the server and/or appliance to be managed as part of the storage pool 668. Examples of such storage include SSDs 672, HDDs, “spindle drives,” or other types of local storage that is directly attached (e.g., direct attached storage, DAS 674). These storage devices, both local and networked, collectively form a storage pool 668. Virtual disks (or “vDisks”) can be structured from the storage devices in the storage pool 668, as described in more detail below. As used herein, the term vDisk refers to the storage abstraction that is exposed by a controller/service VM to be used by a user VM or a user container (CT). In some embodiments, the vDisk is exposed via iSCSI (“internet small computer system interface”) or NFS (“network file system”) and is mounted as a virtual disk on the user VM.

Each server 650a or 650b runs virtualization software, such as VMware ESX(i), Microsoft Hyper-V, or RedHat KVM. The virtualization software includes a hypervisor 662a-b to manage the interactions between the underlying hardware and the one or more user CTs that run client software, such as containerized applications.

The servers 650a-b may implement virtual machines with an operating system 664a-b that supports containers (e.g., Linux) and VM software, such as hypervisors 662a-b. In particular, as illustrated in FIG. 6A for example, node or server 650a runs a controller VM 658a and a user container VM 552a that runs one or more containers 654a-d from a user OS 655a. Each of the user containers may run a container image that may be layered to appear as a single file-system for that container. For example, a base layer may correspond to a Linux Ubuntu image, with an application execution layer on top; the application execution layer corresponding to a read/write execution environment for applications, such as MySQL, web servers, databases or other applications.

In some embodiments, the controller virtual machines 658a-b are used to manage storage and I/O activities for the user containers 654a-d. The controller virtualized computer is the “Storage Controller” in the currently described architecture. Multiple such storage controllers coordinate within a cluster to form a single-system. The Controller VMs 658a-b are not formed as part of specific implementations of respective hypervisors 662a-b. Instead, each controller VM runs as a virtual machine above its respective hypervisors 662a-b on the various servers 650a and 650b, and work together to form a distributed system 660 that manages all the storage resources, including the locally attached storage 670/680 the networked storage 678, and the cloud storage 676.

Each controller VM 658a-b exports one or more block devices or NFS server targets that appear as disks to the user container VM 652a-b. These disks are virtual, since they are implemented by the software running inside the controller VMs 658a-b. Thus, to the User-Container VMs 652a-b, the controller VMs 658a-b appear to be exporting a clustered storage appliance that contains some disks. All user data (including the operating system) in the user-container VMs 652a-b resides on these virtual disks. The containers run from within the respective user container VMs 652a-b may use the user OSs 655a-b to run isolated containerized directories. Further, each user OS 655a-b may have a container manager installed (e.g., Docker, LXC) to run/manage containers on each respective user container VM 652a-b.

Significant performance advantages can be gained by allowing the virtualization system to access and utilize local (e.g., server-internal) storage 670 as disclosed herein. This is because I/O performance is typically much faster when performing access to local storage 670 as compared to performing access to networked storage 678 across a network 666. This faster performance for locally attached storage 670 can be increased even further by using certain types of optimized local storage devices, such as SSDs 672.

Once the virtualization system is capable of managing and accessing locally attached storage, as is the case with the present embodiment, various optimizations can then be implemented to improve system performance even further. For example, the data to be stored in the various storage devices can be analyzed and categorized to determine which specific device should optimally be used to store the items of data. Data that needs to be accessed much faster or more frequently can be identified for storage in the locally attached storage 670. On the other hand, data that does not require fast access or which is accessed infrequently can be stored in the networked storage devices 678 or in cloud storage 676. Further details regarding an exemplary approach for implementing the virtualization environment are described in U.S. Pat. No. 8,601,473, issued on Dec. 3, 2013, which is hereby incorporated by reference in its entirety.

In this way, the security and robustness of a distributed storage system using virtual machines (as illustrated in FIG. 6A) may be combined with efficiency and consistency of a container virtualized computer/application environment.

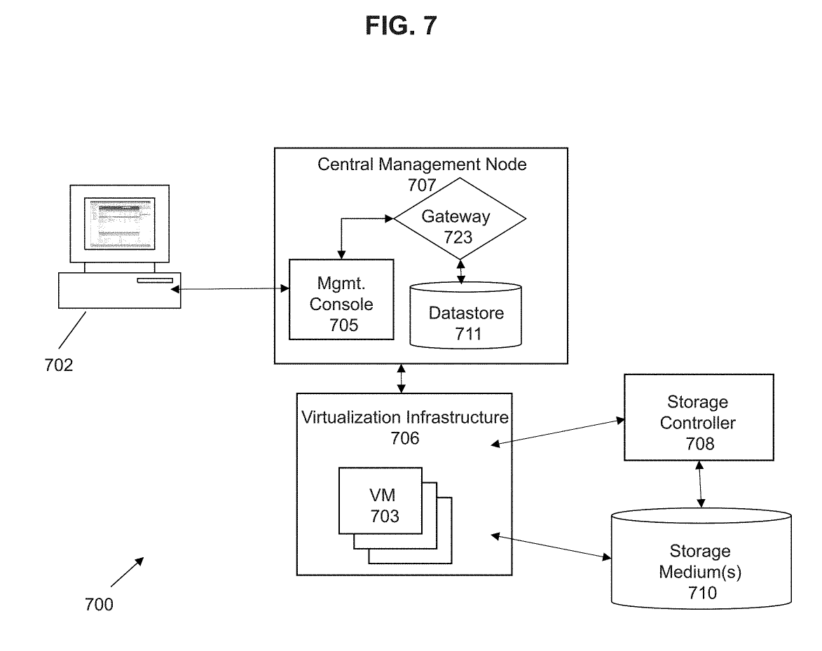

FIG. 7 illustrates a system 700 to implement a virtualization management console 705 according to some embodiments of the invention. In some embodiments, the nodes 106 at the server side 102 may be operated via a virtualization management console, such as a management console.

The system 700 includes one or more users at one or more user stations 702 that use the system 700 to operate the virtualization system 700 and/or management console 705. The user station 702 comprises any type of computing station that may be used to operate or interface with the system 700. Examples of such user stations include, for example, workstations, personal computers, or remote computing terminals. The user station 702 comprises a display device, such as a display monitor, for displaying a user interface to users at the user station. The user station 702 also comprises one or more input devices for the user to provide operational control over the activities of the system 700, such as a mouse or keyboard to manipulate a pointing object in a graphical user interface.

System 700 includes virtualization infrastructure 706, comprising any processing components necessary to implement and provision one or more VMs 703. This may include management components to obtain the status of, to configure, and/or to control the operation of one or more storage controllers and/or storage mediums 710. Data for the VMs 703 are stored in a tangible computer readable storage device 710. The computer readable storage device 710 comprises any combination of hardware and software that allows for ready access to the data that is located at the computer readable storage device 710. The storage controller 708 is used to manage the access and operation of the computer readable storage device 710. While the storage controller is shown as a separate component here, it is noted that any suitable storage controller configuration may be employed. For example, in some embodiments, the storage controller can be implemented as a virtual machine as described in more detail below. As noted in more detail below, the virtualization infrastructure 706 may correspond to a cluster of multiple nodes that are integrated as a single system.

System 700 includes a management console 705 included in a management node 707. The management console 705 provides an interface that permits an administrator to manage and administer the operation of the system. According to some embodiments, the management console 705 comprises a javascript program that is executed to display a management user interface within a web browser at the user station 702. In some embodiments, the storage controller exposes an API or GUI to create, read, update, delete (CRUD) data stores at the computer readable medium 710, which can be managed by the management console 705.

In operation in some embodiments, a web browser at the user station 702 is used to display a web-based user interface for the management console. The management console 705 corresponds to javascript code to implement the user interface. Metadata regarding the system 700 is maintained at a data store 711, which collects data relating to the virtualization infrastructure 706, the storage mediums 710, and/or datastores at the storage mediums. The javascript code interacts with a gateway 723 to obtain the metadata to be displayed in the user interface. In some embodiments, the gateway comprises a web server and servlet container, e.g., implemented using Apache Tomcat. Further details regarding methods and mechanisms for implementing virtualization management console illustrated in FIG. 7 are described in U.S. Provisional Patent Application No. 62/108,515, filed on Jan. 27, 2015, which is hereby incorporated by reference in its entirety.

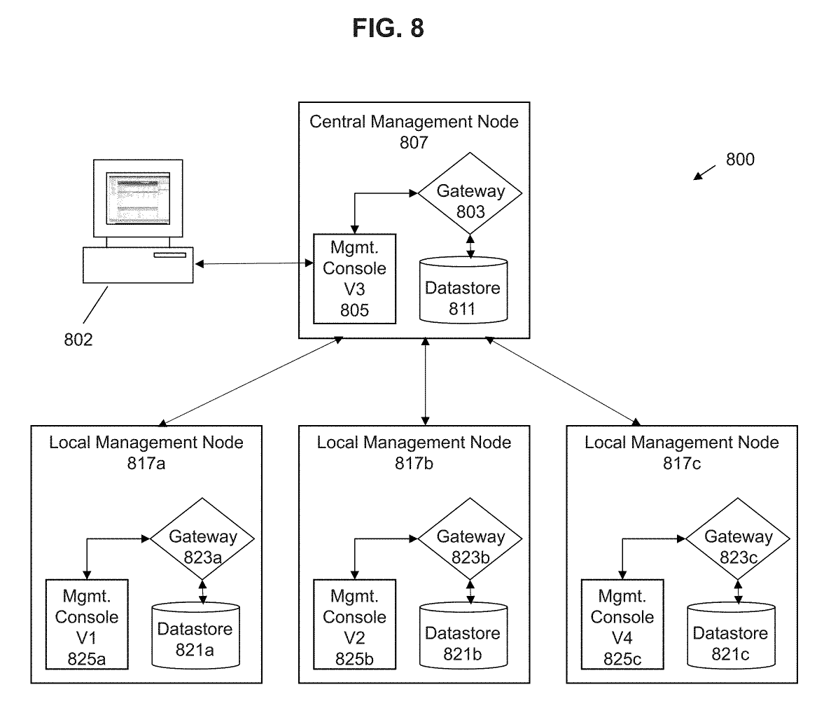

FIG. 8 illustrates a larger computing environment having multiple underlying systems/clusters that need to be managed, where a separate management node exists for each of the underlying systems/clusters.

Similar to FIG. 7, the system 800 includes one or more users at one or more user stations 802 that use the system 800 to operate the virtualization system 800 and/or management console 805. The user station 802 comprises any type of computing station that may be used to operate or interface with the system 800 and a display device, such as a display monitor, for displaying a user interface to users at the user station. The user station 802 also comprises one or more input devices for the user to provide operational control over the activities of the system 800, as described above.

The server side 102 of the client-server system may include a central management node 807 for one or more clusters that includes its own management console 805, gateway 803, and datastore 811. Shown here are local management nodes 817a, 817b, and 817c. Each of these management nodes includes its own management console 825a-c, gateway 823a-c, and datastore 821a-c. Further details regarding methods and mechanisms for implementing virtualization management console illustrated in FIG. 8 are described in U.S. Provisional Patent Application No. 62/108,515, filed on Jan. 27, 2015, which is hereby incorporated by reference in its entirety.

### System Architecture

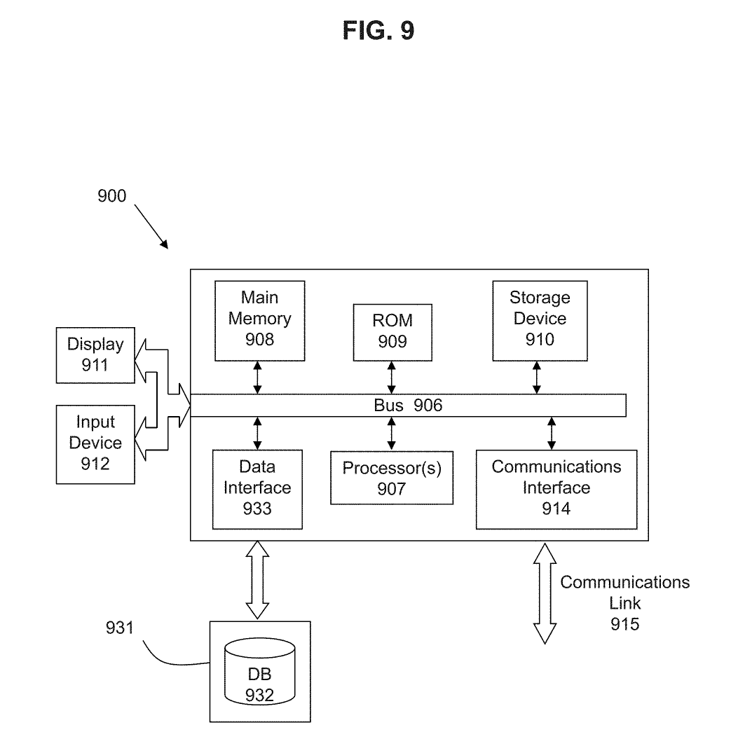

FIG. 9 is a block diagram of an illustrative computing system 900 suitable for implementing an embodiment of the present invention. Computer system 800 includes a bus 806 or other communication mechanism for communicating information, which interconnects subsystems and devices, such as processor 907, system memory 908 (e.g., RAM), static storage device 909 (e.g., ROM), disk drive 910 (e.g., magnetic or optical), communication interface 914 (e.g., modem or Ethernet card), display 911 (e.g., CRT or LCD), input device 912 (e.g., keyboard), and cursor control.

According to some embodiments of the invention, computer system 900 performs specific operations by processor 907 executing one or more sequences of one or more instructions contained in system memory 908. Such instructions may be read into system memory 908 from another computer readable/usable medium, such as static storage device 909 or disk drive 910. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 907 for execution. Such a medium may take many forms, including but not limited to, non-volatile media and volatile media. Non-volatile media includes, for example, optical or magnetic disks, such as disk drive 910. Volatile media includes dynamic memory, such as system memory 908.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 900. According to other embodiments of the invention, two or more computer systems 900 coupled by communication link 910 (e.g., LAN, PTSN, or wireless network) may perform the sequence of instructions required to practice the invention in coordination with one another.

Computer system 900 may transmit and receive messages, data, and instructions, including program, i.e., application code, through communication link 915 and communication interface 914. Received program code may be executed by processor 907 as it is received, and/or stored in disk drive 910, or other non-volatile storage for later execution. A database 932 in a storage medium 931 may be used to store data accessible by the system 900.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method for achieving session failover for traffic directed to a server side of a client-server system, the method comprising:
receiving, at a first node of a plurality of nodes comprising the server side of the client-server system, a first request corresponding to a user account maintained in the server side, the first request comprising login credentials specific to the user account;
responsive to determining that the login credentials are valid, generating a session specific to the user account and a first set of values associated with the session at the first node, the first set of values comprising at least session metadata, a timeframe associated with the session, and a signature associated with the session, the signature generated based at least in part on the session metadata, the timeframe, and a first value shared among the plurality of nodes;
sending the session and the first set of values associated with the session from the first node to a client from which the first request originated;
receiving, at a second node of the plurality of nodes, a second request to access the session, the second request comprising a second set of values, the second set of values comprising at least a second value corresponding to the signature;
obtaining, at the second node, a plurality of values from the second value corresponding to the signature using the first value shared among the plurality of nodes; and
granting or denying access to the session based at least in part on whether the plurality of values match a subset of the second set of values corresponding to the session metadata and the timeframe associated with the session.

2. The method of claim 1, wherein the first set of values associated with the session is sent from the first node to the client from which the first request originated in an HTTP cookie header and the first set of values is stored as a cookie in a persistent storage location accessible via a browser executing on the client from which the first request originated.

3. The method of claim 1, wherein granting or denying access to the session is further based at least in part on one or more of: whether an IP address included among the second set of values matches an additional IP address of an additional client from which the second request originated and whether the timeframe associated with the session has elapsed.

4. The method of claim 1, wherein the first value shared among the plurality of nodes is shared among a plurality of applications and the user account maintained in the server side comprises a user account for a first application of the plurality of applications.

5. The method of claim 4, further comprising:
receiving, at a node of the plurality of nodes, a third request to access a second application of the plurality of applications, the third request comprising the second set of values; and
granting or denying access to the second application based at least in part on whether the plurality of values match the subset of the second set of values corresponding to the session metadata and the timeframe associated with the session.

6. The method of claim 1, wherein the first value shared among the plurality of nodes is changed periodically and a current first value and a previous first value are shared among the plurality of nodes.

7. The method of claim 6, wherein obtaining the plurality of values from the second value corresponding to the signature using the first value shared among the plurality of nodes comprises:
obtaining the plurality of values from the value corresponding to the signature using the current first value or the previous first value.

8. The method of claim 1, wherein granting or denying access to the session based at least in part on whether the plurality of values match the subset of the second set of values corresponding to the session metadata and the timeframe associated with the session comprises:
granting access to the session if the plurality of values match the subset of the second set of values corresponding to the session metadata and the timeframe associated with the session; and
denying access to the session if the plurality of values does not match the subset of the second set of values corresponding to the session metadata and the timeframe associated with the session.

9. A computer program product embodied on a non-transitory computer readable medium, the computer readable medium having stored thereon a sequence of instructions which, when executed by a processor causes the processor to execute a method for achieving session failover for traffic directed to a server side of a client-server system, the method comprising:
receiving, at a first node of a plurality of nodes comprising the server side of the client-server system, a first request corresponding to a user account maintained in the server side, the first request comprising login credentials specific to the user account;
responsive to determining that the login credentials are valid, generating a session specific to the user account and a first set of values associated with the session at the first node, the first set of values comprising at least session metadata, a timeframe associated with the session, and a signature associated with the session, the signature generated based at least in part on the session metadata, the timeframe, and a first value shared among the plurality of nodes;
sending the session and the first set of values associated with the session from the first node to a client from which the first request originated;
receiving, at a second node of the plurality of nodes, a second request to access the session, the second request comprising a second set of values, the second set of values comprising at least a second value corresponding to the signature;
obtaining, at the second node, a plurality of values from the second value corresponding to the signature using the first value shared among the plurality of nodes; and
granting or denying access to the session based at least in part on whether the plurality of values match a subset of the second set of values corresponding to the session metadata and the timeframe associated with the session.

10. The computer program product of claim 9, wherein the first set of values associated with the session is sent from the first node to the client from which the first request originated in an HTTP cookie header and the first set of values is stored as a cookie in a persistent storage location accessible via a browser executing on the client from which the first request originated.

11. The computer program product of claim 9, wherein granting or denying access to the session is further based at least in part on one or more of: whether an IP address included among the second set of values matches an additional IP address of an additional client from which the second request originated and whether the timeframe associated with the session has elapsed.

12. The computer program product of claim 9, wherein the first value shared among the plurality of nodes is shared among a plurality of applications and the user account maintained in the server side comprises a user account for a first application of the plurality of applications.

13. The computer program product of claim 12, wherein the sequence of instructions, when executed by a processor, further executes the steps of:
receiving, at a node of the plurality of nodes, a third request to access a second application of the plurality of applications, the third request comprising the second set of values; and
granting or denying access to the second application based at least in part on whether the plurality of values match the subset of the second set of values corresponding to the session metadata and the timeframe associated with the session.

14. The computer program product of claim 9, wherein the first value shared among the plurality of nodes is changed periodically and a current first value and a previous first value are shared among the plurality of nodes.

15. The computer program product of claim 14, wherein obtaining the plurality of values from the second value corresponding to the signature using the first value shared among the plurality of nodes comprises:
obtaining the plurality of values from the value corresponding to the signature using the current first value or the previous first value.

16. The computer program product of claim 15, wherein granting or denying access to the session based at least in part on whether the plurality of values match the subset of the second set of values corresponding to the session metadata and the timeframe associated with the session comprises:
granting access to the session if the plurality of values match the subset of the second set of values corresponding to the session metadata and the timeframe associated with the session; and
denying access to the session if the plurality of values does not match the subset of the second set of values corresponding to the session metadata and the timeframe associated with the session.

17. A computer system to implement a method for achieving session failover for traffic directed to a server side of a client-server system, comprising:
a processor;
a memory for holding programmable code; and
wherein the programmable code includes instructions for:
receiving, at a first node of a plurality of nodes comprising the server side of the client-server system, a first request corresponding to a user account maintained in the server side, the first request comprising login credentials specific to the user account;
responsive to determining that the login credentials are valid, generating a session specific to the user account and a first set of values associated with the session at the first node, the first set of values comprising at least session metadata, a timeframe associated with the session, and a signature associated with the session, the signature generated based at least in part on the session metadata, the timeframe, and a first value shared among the plurality of nodes;
sending the session and the first set of values associated with the session from the first node to a client from which the first request originated;
receiving, at a second node of the plurality of nodes, a second request to access the session, the second request comprising a second set of values, the second set of values comprising at least a second value corresponding to the signature;
obtaining, at the second node, a plurality of values from the second value corresponding to the signature using the first value shared among the plurality of nodes; and
granting or denying access to the session based at least in part on whether the plurality of values match a subset of the second set of values corresponding to the session metadata and the timeframe associated with the session.

18. The computer system of claim 17, wherein the first set of values associated with the session is sent from the first node to the client from which the first request originated in an HTTP cookie header and the first set of values is stored as a cookie in a persistent storage location accessible via a browser executing on the client from which the first request originated.

19. The computer system of claim 17, wherein granting or denying access to the session is further based at least in part on one or more of: whether an IP address included among the second set of values matches an additional IP address of an additional client from which the second request originated and whether the timeframe associated with the session has elapsed.

20. The computer system of claim 17, wherein the first value shared among the plurality of nodes is shared among a plurality of applications and the user account maintained in the server side comprises a user account for a first application of the plurality of applications.

21. The computer system of claim 20, wherein the programmable code further includes instructions for:
receiving, at a node of the plurality of nodes, a third request to access a second application of the plurality of applications, the third request comprising the second set of values; and
granting or denying access to the second application based at least in part on whether the plurality of values match the subset of the second set of values corresponding to the session metadata and the timeframe associated with the session.

22. The computer system of claim 17, wherein the first value shared among the plurality of nodes is changed periodically and a current first value and a previous first value are shared among the plurality of nodes.

23. The computer system of claim 22, wherein obtaining the plurality of values from the second value corresponding to the signature using the first value shared among the plurality of nodes comprises:
obtaining the plurality of values from the value corresponding to the signature using the current first value or the previous first value.

24. The computer system of claim 17, wherein granting or denying access to the session based at least in part on whether the plurality of values match the subset of the second set of values corresponding to the session metadata and the timeframe associated with the session comprises:
granting access to the session if the plurality of values match the subset of the second set of values corresponding to the set of session metadata and the timeframe associated with the session; and
denying access to the session if the plurality of values does not match the subset of the second set of values corresponding to the session metadata and the timeframe associated with the session.
